SEQUENCE LISTING (14 sequences)

SEQ ID NO: 1 - DNA, 29 bp, synthetic construct
  source 1..29: mol_type = other DNA
  modified_base 23: mod_base = OTHER; note = uracil
aatgatacggcgaccaccgagatctacac

SEQ ID NO: 2 - DNA, 29 bp, synthetic construct
  source 1..29: mol_type = other DNA
  modified_base 23: mod_base = OTHER; note = alkene-thymidine
aatgatacggcgaccaccgaganctacac

SEQ ID NO: 3 - DNA, 29 bp, synthetic construct
  source 1..29: mol_type = other DNA
  modified_base 23: mod_base = i
aatgatacggcgaccaccgaganctacac

SEQ ID NO: 4 - DNA, 24 bp, synthetic construct
  source 1..24: mol_type = other DNA
  modified_base 22: mod_base = OTHER; note = 8-oxoguanine
caagcagaagacggcatacganat

SEQ ID NO: 5 - DNA, 24 bp, synthetic construct
  source 1..24: mol_type = other DNA
  modified_base 20: mod_base = OTHER; note = 8-oxoguanine
caagcagaagacggcatacnagat

SEQ ID NO: 6 - DNA, 24 bp, synthetic construct
  source 1..24: mol_type = other DNA
  modified_base 20: mod_base = OTHER; note = 8-oxoguanine
  modified_base 22: mod_base = OTHER; note = 8-oxoguanine
caagcagaagacggcatacnanat

SEQ ID NO: 7 - DNA, 24 bp, synthetic construct
  source 1..24: mol_type = other DNA
  modified_base 22: mod_base = OTHER; note = uracil
caagcagaagacggcatacgatat

SEQ ID NO: 8 - DNA, 24 bp, synthetic construct
  source 1..24: mol_type = other DNA
  modified_base 20: mod_base = OTHER; note = uracil
caagcagaagacggcatactagat

SEQ ID NO: 9 - DNA, 29 bp, synthetic construct
  source 1..29: mol_type = other DNA
  modified_base 23: mod_base = OTHER; note = allyl-T
aatgatacggcgaccaccgaganctacac

SEQ ID NO: 10 - DNA, 35 bp, synthetic construct
  source 1..35: mol_type = other DNA
gctggcacgtccgaacgcttcgttaatccgttgag

SEQ ID NO: 11 - DNA, 35 bp, synthetic construct
  source 1..35: mol_type = other DNA
cgtcgtctgccatggcgcttcggtggatatgaact

SEQ ID NO: 12 - DNA, 35 bp, synthetic construct
  source 1..35: mol_type = other DNA
acggccgctaatatcaacgcgtcgaatccgcaact

SEQ ID NO: 13 - DNA, 34 bp, synthetic construct
  source 1..34: mol_type = other DNA
gccgcgttacgttagccggactattcgatgcagc

SEQ ID NO: 14 - DNA, 24 bp, synthetic construct
  source 1..24: mol_type = other DNA
aggaggaggaggaggaggaggagg

(19) United States
(12) Patent Application Publication
(10) Pub. No.: US 2026/0273495 A1
(43) Pub. Date: Sep. 17, 2026

(54) METHODS FOR MAKING FLOW CELL SURFACES

(71) Applicant: ILLUMINA, INC., San Diego, CA (US)

(72) Inventors: Sahngki Hong, San Diego, CA (US); Lewis J. Kraft, Ackworth, GA (US); Alexandra Szemjonov, Cambridge (GB); Brandon Wenning, San Diego, CA (US)

(21) Appl. No.: 19/168,500

(22) PCT Filed: Mar. 27, 2024
(86) PCT No.: PCT/US2024/021758

§ 371 Date: Sep. 24, 2025

Related U.S. Application Data
(60) Provisional application No. 63/493,229, filed on Mar. 30, 2023.

(51) Int. Cl. B01J 19/00

(52) U.S. Cl. CPC B01J 19/0046; B01J 2219/00605; B01J 2219/00621; B01J 2219/00626

(57) ABSTRACT

In an example of a method for making a flow cell, a multi-layer stack including a base support, a first resin layer, an inert layer, and a second resin layer is contacted with a working stamp to define a plurality of initial discrete regions in the second resin layer. Each of the initial discrete regions includes a concave region and a convex region that are directly adjacent to one another. The multi-layer stack is etched (i) at each concave region to form a depression through the inert layer and in the first resin layer, (ii) at each convex region to form a pillar in the second resin layer, and (iii) to expose a surface of the inert layer around each of a plurality of final discrete regions. A first primer set is selectively attached in each depression, and a second primer set is selectively attached over each pillar.

### CROSS-REFERENCE TO RELATED APPLICATIONS

This application claims the benefit of U.S. Provisional Application Ser. No. 63/493,229, filed Mar. 30, 2023, the content of which is incorporated by reference herein in its entirety.

### REFERENCE TO SEQUENCE LISTING

The Sequence Listing submitted herewith is hereby incorporated by reference in its entirety. The name of the file is ILI257BPCT_IP-2553-PCT_Sequence_Listing.xml, the size of the file is 18,613 bytes, and the date of creation of the file is Mar. 21, 2024.

### BACKGROUND

Some available platforms for sequencing nucleic acids and other biomolecules utilize a sequencing-by-synthesis approach. With this approach, a nascent strand is synthesized, and the addition of each monomer (e.g., nucleotide) to the growing strand is detected optically and/or electronically. Because a template strand directs synthesis of the nascent strand, one can infer the sequence of the template DNA from the series of nucleotide monomers that were added to the growing strand during the synthesis process. In some examples of sequencing-by-synthesis, simultaneous paired-end sequencing may be used, where forward strands and reverse strands are sequenced at the same time.

In some sequencing-by-synthesis approaches, nanoimprinting technology is employed to enable the economic and effective production of nanostructures. Nanoimprint lithography, for example, employs direct mechanical deformation of a material by a stamp having distinct features. The material may be cured while the stamp is in place. This process transfers the shape and/or dimensions of the stamp's features to the material. Nanoimprint lithography can be used to manufacture patterned substrates that are suitable for use in sequencing-by-synthesis techniques.

### SUMMARY

Several example methods are described herein for forming flow cells including layers of two or more different resins. The resin layers are patterned (e.g., using nanoimprinting techniques) to define reactive features on a flow cell surface where sequencing surface chemistry may be introduced. The two different resin layers may be selected to include functional groups that are orthogonally reactive, which enables selective attachment of different surface chemistries without complex patterning techniques. In the examples disclosed herein, patterning techniques such as photoresist development and polishing are not utilized, and thus the methods simplify flow cell manufacturing workflows.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a top view of an example of a flow cell;

FIG. 1B is an enlarged, partially cutaway, and perspective view of an example of an architecture within a flow channel of the flow cell;

FIG. 1C is an enlarged, partially cutaway, and perspective view of an example of another architecture within a flow channel of the flow cell;

FIG. 1D is an enlarged, partially cutaway, and perspective view of an example of yet another architecture within a flow channel of the flow cell;

FIG. 2A is a schematic view of an example of first and second primer sets that are used in some examples of the flow cells disclosed herein;

FIG. 2B is a schematic view of another example of first and second primer sets that are used in other examples of the flow cells disclosed herein;

FIG. 2C is a schematic view of still another example of first and second primer sets that are used in still other examples of the flow cells disclosed herein;

FIG. 2D is a schematic view of yet another example of first and second primer sets that are used in yet other examples of the flow cells disclosed herein;

FIG. 3A through FIG. 3C are schematic views that together illustrate an example method of generating a multi-layer stack that may be used in an example of a method disclosed herein, where FIG. 3A depicts the application of a first resin layer having a first functional group over a base support, FIG. 3B depicts the application of an inert layer over the first resin layer, and FIG. 3C depicts the application of a second resin layer having a second functional group over the inert layer;

FIG. 4A through FIG. 4C are schematic views that together illustrate an example method of forming a discrete region including a depression and a pillar in the multi-layer stack depicted in FIG. 3C, where FIG. 4A depicts contacting the second resin layer of the multi-layer stack with a working stamp to form an initial discrete region including a concave region and a convex region that are directly adjacent to one another, FIG. 4B depicts etching at least some of the multi-layer stack to form a depression at the concave region and to form a pillar at the convex region, and FIG. 4C depicts the selective attachment of primer sets within the depression and over the pillar;

FIG. 5A is a perspective view an example of a working stamp that may be used in the example method depicted in FIG. 4A through FIG. 4C;

FIG. 5B is a cross-sectional view taken along line 5B-5B of the working stamp of FIG. 5A;

FIG. 6A through FIG. 6C are schematic views that together illustrate an example of a method of forming a multi-depth depression in a multi-layer stack, where FIG. 6A depicts contacting one or more resin layers of the multi-layer stack with a working stamp to define a multi-depth feature including a shallow region and a deep region, FIG. 6B depicts etching at least some of the resin layers to form a multi-depth depression including a shallow portion at the shallow region and a deep portion at the deep region, the shallow and deep portions being orthogonally reactive, and FIG. 6C depicts the selective attachment of primer sets within the shallow portion and within the deep portion of the multi-depth depression;

FIG. 7A through FIG. 7C are schematic views that together illustrate an example of a method of forming a multi-height protrusion in a multi-layer stack, where FIG. 7A depicts imprinting a resin layer of the multi-layer stack with a working stamp to form a multi-height convex region including a first region with a first height and a second region with a second height, FIG. 7B depicts the multi-height protrusion including different portions that are orthogonally reactive formed by etching at least some of the multi-layer stack, and FIG. 7C depicts the selective attachment of primer sets over the different portions of the multi-height protrusion; and

FIG. 8A through FIG. 8D are schematic views that depict variations of the discrete features of FIG. 1B, where FIG. 8A depicts slanted sides and slanted sidewalls, FIG. 8B depicts a horizontal gap between the pillar and depression, FIG. 8C depicts the depression with an undercut, and FIG. 8D depicts a vertical gap between the pillar and the depression.

### DETAILED DESCRIPTION

Examples of the flow cells and methods disclosed herein may be used for sequencing processes, examples of which include simultaneous paired-end nucleic acid sequencing. For simultaneous paired-end sequencing, different primer sets are attached to different regions of a flow cell. The primer sets may be controlled so that the cleaving (linearization) chemistry is orthogonal in the different regions. In these examples, orthogonal cleaving chemistry of the primer sets may be realized through identical cleavage sites that are attached to different primers in the different sets, or through different cleavage sites that are attached to different primers in the different sets.

Each of the different regions of the flow cell (i.e., to which the primer sets are respectively attached) may include a functionalization that is controlled to enable primer set attachment, either directly to a polymeric hydrogel that is present in the flow cell or through an additional polymeric hydrogel. As such, in the methods disclosed herein, the functional groups of the resins that define the different regions of the flow cell are orthogonal with respect to one another.

As an example, a first primer set may be attached within a depression that is defined in a surface of the flow cell, and a second primer set may be attached over a pillar that is (i) positioned over the flow cell surface and (ii) adjacent to the depression. As another example, the first primer set may be attached within a deep portion of a multi-depth depression that is defined in the flow cell surface, and the second primer set may be attached within a shallow portion of the multi-depth depression. As yet another example, the first primer set may be attached to a first portion of a multi-height protrusion on the flow cell surface, the first portion having a first height, and a second primer set may be attached to a second portion of the multi-height protrusion, the second portion having a second height that is different from the first height.

As such, the methods described herein enable a cluster of forward strands (e.g., of DNA) to be generated in one region of the flow cell, and a cluster of reverse strands to be generated in another region of the flow cell. In any of the example methods disclosed herein, the forward and reverse strands are in spatially distinct regions, which separates the fluorescent signals from both reads while allowing for simultaneous base calling of each read. Several example methods are described to generate these flow cells.

It is to be understood that terms used herein will take on their ordinary meaning in the relevant art unless specified otherwise. Several terms used herein and their meanings are set forth below.

### Definitions

The singular forms “a”, “an”, and “the” include plural referents unless the context clearly dictates otherwise.

The terms comprising, including, containing and various forms of these terms are synonymous with each other and are meant to be equally broad.

The terms top, bottom, lower, upper, on, etc. are used herein to describe the flow cell and/or the various components of the flow cell. It is to be understood that these directional terms are not meant to imply a specific orientation, but are used to designate relative orientation between components. The use of directional terms should not be interpreted to limit the examples disclosed herein to any specific orientation(s).

The terms first, second, etc. also are not meant to imply a specific orientation or order, but rather are used to distinguish one component from another.

The term “each,” when used in reference to a collection of items, is intended to identify an individual item in the collection, but does not necessarily refer to every item in the collection. Exceptions can occur if explicit disclosure or context clearly dictates otherwise.

It is to be understood that the ranges provided herein include the stated range and any value or sub-range within the stated range, as if such values or sub-ranges were explicitly recited. For example, a range of about 400 nm to about 1 μm (1000 nm), should be interpreted to include not only the explicitly recited limits of about 400 nm to about 1 μm, but also to include individual values, such as about 708 nm, about 945.5 nm, etc., and sub-ranges, such as from about 425 nm to about 825 nm, from about 550 nm to about 940 nm, etc. Furthermore, when “about” and/or “substantially” are/is utilized to describe a value, the term(s) are/is meant to encompass minor variations (up to +/−10%) from the stated value.

As used herein, the term “attached” refers to the state of two things being joined, fastened, adhered, connected or bound to each other, either directly or indirectly. For example, a nucleic acid can be attached to a functionalized polymer by a covalent or non-covalent bond. A covalent bond is characterized by the sharing of pairs of electrons between atoms. A non-covalent bond is a physical bond that does not involve the sharing of pairs of electrons and can include, for example, hydrogen bonds, ionic bonds, Van der Waals forces, hydrophilic interactions and hydrophobic interactions.

As used herein, a “bonding region” refers to an area of a patterned substrate that is to be bonded to another material, which may be, as examples, a lid, a substrate, etc., or combinations thereof (e.g., a substrate and a lid). The bond that is formed at the bonding region may be a chemical bond (as described herein), or a mechanical bond (e.g., using a fastener, etc.).

A “patterned substrate” refers to a multi-layer structure that includes surface chemistry in one or more patterns. The multi-layer structure includes two orthogonally reactive resins that are capable of attaching chemically different primers or polymeric hydrogels. In some examples, the multi-layer structure has been exposed to patterning techniques (e.g., stamping, etching, lithography, etc.) in order to generate the patterns for the surface chemistry. The patterned substrate may be generated via any of the methods disclosed hereinbelow.

A “patterned resin” refers to any polymer that can be patterned to form the discrete regions where surface chemistries can be attached. Specific examples of resins and techniques for patterning the resins will be described further hereinbelow.

The term “initial discrete region” refers to an area of a multi-layer stack that is patterned to define a concave region and a convex region, and the term “discrete region” refers to an area of a patterned substrate that includes a depression and a pillar that respectively correspond to the concave region and the convex region of the initial discrete region.

The “multi-layer stack” refers to at least two different materials that are layered and that can be patterned to form an example of the multi-layered structure disclosed herein. Examples of the multi-layer stack disclosed herein include multiple orthogonally reactive resin layers.

As used herein, the term “flow cell” is intended to mean a vessel having a flow channel where a reaction can be carried out, an inlet for delivering reagent(s) to the flow channel, and an outlet for removing reagent(s) from the flow channel. In some examples, the flow cell also enables the detection of the reaction that occurs in the flow cell. For example, the flow cell can include one or more transparent surfaces allowing for the optical detection of arrays, optically labeled molecules, or the like.

As used herein, a “flow channel” or “channel” may be an area defined between two bonded components, which can selectively receive a liquid sample. In some examples, the flow channel may be defined between a patterned substrate and a lid, and thus may be in fluid communication with one or more surface chemistries on the patterned substrate. In other examples, the flow channel may be defined between two patterned substrates (each of which has sequencing chemistry thereon), and thus may be in fluid communication with the surface chemistry of the substrates.

As used herein, the term “depression” refers to a discrete concave feature in a patterned substrate having a surface opening. The depression may be at least partially surrounded by interstitial region(s) of the patterned substrate. Depressions can have any of a variety of shapes at their opening in a surface including, as examples, round, elliptical, square, polygonal, star shaped (with any number of vertices), etc. The cross-section of a depression taken orthogonally with the surface can be curved, square, polygonal, hyperbolic, conical, angular, etc. As an example, the depression can be a “multi-depth depression,” meaning that the depression has a deep portion and a shallow portion (the depth of each portion being relative to a plane that is defined by the surface opening). As another example, the depression may be a well or two interconnected wells. The depression may also have more complex architectures, such as ridges, step features, etc.

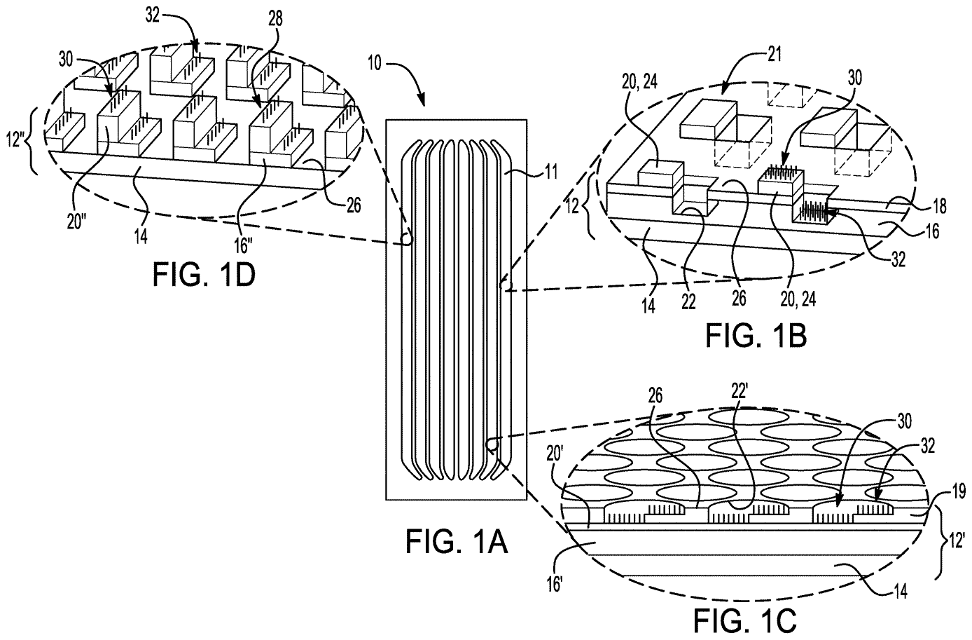

As used herein, the term “interstitial region” refers to an area, e.g., of a patterned substrate, that separates features defined in/on the substrate surface from one another. For example, the interstitial region(s) may separate a discrete region including a pillar and a depression from another discrete region including another pillar and another depression (as shown in FIG. 1B). As another example, the interstitial region(s) may separate a multi-depth depression from another multi-depth depression (as shown in FIG. 1C). As yet another example, the interstitial regions may separate one multi-height protrusion from another multi-height protrusion (as shown in FIG. 1D). The discrete regions, or multi-depth depressions, or multi-height protrusions that are separated from each other by the interstitial regions can be discrete, i.e., lacking physical contact with each other. In some examples, the interstitial region is continuous, whereas the discrete regions, or the multi-depth depressions, or the multi-height protrusions are discrete, for example, as is the case for a plurality of multi-depth depressions defined in an otherwise continuous surface. The separation provided by an interstitial region can be partial or full separation.

As used herein, a “primer” is defined as a single stranded nucleic acid sequence (e.g., single strand DNA or single strand RNA). Some primers, referred to herein as amplification primers, serve as a starting point for template amplification and cluster generation. Other primers, referred to herein as sequencing primers, serve as a starting point for DNA synthesis. The 5′ terminus of the primer may be modified to allow a coupling reaction with a functional group of a polymer. The primer length can be any number of bases long and can include a variety of non-natural nucleotides. In an example, the sequencing primer is a short strand, ranging from 10 to 60 bases, or from 20 to 40 bases.

As used herein, a “nucleotide” includes a nitrogen containing heterocyclic base, a sugar, and one or more phosphate groups. Nucleotides are monomeric units of a nucleic acid sequence. In RNA, the sugar is a ribose, and in DNA, the sugar is a deoxyribose, i.e. a sugar lacking a hydroxyl group that is present at the 2′ position in ribose. The nitrogen containing heterocyclic base (i.e., nucleobase) can be a purine base or a pyrimidine base. Purine bases include adenine (A) and guanine (G), and modified derivatives or analogs thereof. Pyrimidine bases include cytosine (C), thymine (T), and uracil (U), and modified derivatives or analogs thereof. The C-1 atom of deoxyribose is bonded to the N-1 atom of a pyrimidine or to the N-9 atom of a purine. A nucleic acid analog may have any of the phosphate backbone, the sugar, or the nucleobase altered. Examples of nucleic acid analogs include, for example, universal bases or phosphate-sugar backbone analogs, such as peptide nucleic acid (PNA).

The term “depositing,” as used herein, refers to any suitable application technique, which may be manual or automated, and, in some instances, results in modification of surface properties. Generally, depositing may be performed using vapor deposition techniques, coating techniques, grafting techniques, or the like. Some specific examples include chemical vapor deposition (CVD), spray coating (e.g., ultrasonic spray coating), spin coating, dunk or dip coating, doctor blade coating, puddle dispensing, flow through coating, aerosol printing, screen printing, microcontact printing, inkjet printing, or the like.

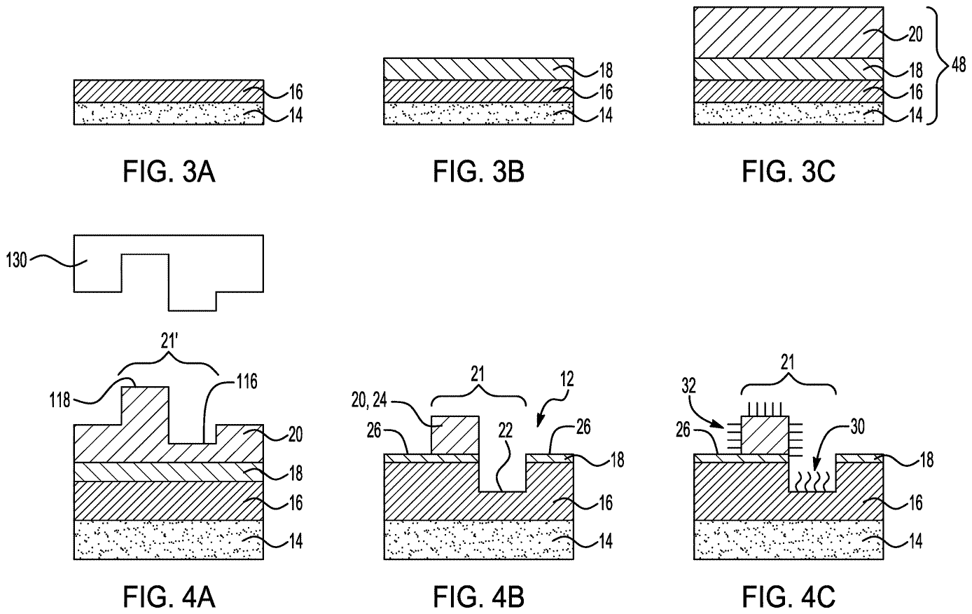

In some examples, the term “over” may mean that one component or material is positioned directly on another component or material. When one is directly on another, the two are in contact with each other. For example, in FIG. 3A, a first resin layer 16 is applied over a base support 14, so that the first resin layer 16 is directly on and in contact with the base support 14.

In other examples, the term “over” may mean that one component or material is positioned indirectly on another component or material. By indirectly on, it is meant that a gap or an additional component or material may be positioned between the two components or materials. For example, in FIG. 3C, a second resin layer 20 is positioned over the first resin layer 16, such that the two are in indirect contact. The inert layer 18 is positioned therebetween.

An “acrylamide monomer” is a monomer with the structure

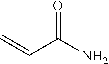

or a monomer including an acrylamide group. Examples of the monomer including an acrylamide group include azido acetamido pentyl acrylamide:

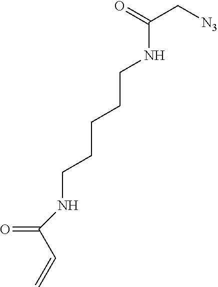 [SMILES: C=CC(=O)NCCCCCNC(=O)CN=[N+]=[N-]]

### and N-isopropylacrylamide:

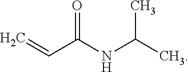

Other acrylamide monomers may be used.

The terms “activate” and “activation” as used herein, refers to a process that generates reactive groups at the surface of a resin layer or a base support. Activation may be accomplished using silanization and/or plasma ashing. While the figures do not depict a separate silanized layer or —OH groups from plasma ashing, it is to be understood that activation generates a silanized layer or —OH groups at the surface of the activated support or layer to covalently attach target molecules (e.g., primers, hydrogels, etc.) to the layer.

An aldehyde, as used herein, is an organic compound containing a functional group with the structure —CHO, which includes a carbonyl center (i.e., a carbon double-bonded to oxygen) with the carbon atom also bonded to hydrogen and an R group, such as an alkyl or other side chain. The general structure of an aldehyde is:

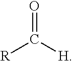

As used herein, “alkyl” refers to a straight or branched hydrocarbon chain that is fully saturated (i.e., contains no double or triple bonds). The alkyl group may have 1 to 20 carbon atoms. Example alkyl groups include methyl, ethyl, propyl, isopropyl, butyl, isobutyl, tertiary butyl, pentyl, hexyl, and the like. As an example, the designation “C1-4 alkyl” indicates that there are one to four carbon atoms in the alkyl chain, i.e., the alkyl chain is selected from the group consisting of methyl, ethyl, propyl, isopropyl, n-butyl, isobutyl, sec-butyl, and t-butyl.

As used herein, “alkenyl” refers to a straight or branched hydrocarbon chain containing one or more double bonds. The alkenyl group may have 2 to 20 carbon atoms. Example alkenyl groups include ethenyl, propenyl, butenyl, pentenyl, hexenyl, and the like.

As used herein, “alkyne” or “alkynyl” refers to a straight or branched hydrocarbon chain containing one or more triple bonds. The alkynyl group may have 2 to 20 carbon atoms.

As used herein, “aryl” refers to an aromatic ring or ring system (i.e., two or more fused rings that share two adjacent carbon atoms) containing only carbon in the ring backbone. When the aryl is a ring system, every ring in the system is aromatic. The aryl group may have 6 to 18 carbon atoms. Examples of aryl groups include phenyl, naphthyl, azulenyl, and anthracenyl.

An “amine” or “amino” functional group refers to an —NRₐR_{b} group, where Rₐ and R_{b} are each independently selected from hydrogen (e.g.,

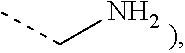

C1-6 alkyl, C2-6 alkenyl, C2-6 alkynyl, C3-7 carbocycle, C6-10 aryl, 5-10 membered heteroaryl, and 5-10 membered heterocycle, as defined herein.

As used herein, the term “attached” refers to the state of two things being joined, fastened, adhered, connected or bound to each other, either directly or indirectly. For example, a nucleic acid can be attached to a functionalized polymer by a covalent or non-covalent bond. A covalent bond is characterized by the sharing of pairs of electrons between atoms. A non-covalent bond is a physical bond that does not involve the sharing of pairs of electrons and can include, for example, hydrogen bonds, ionic bonds, van der Waals forces, hydrophilic interactions and hydrophobic interactions.

An “azide” or “azido” functional group refers to —N₃.

As used herein, a “bonding region” refers to an area of a patterned substrate that is to be bonded to another material, which may be, as examples, a spacer layer, a lid, another patterned substrate, etc., or combinations thereof (e.g., a spacer layer and a lid, or a spacer layer and another patterned substrate). The bond that is formed at the bonding region may be a chemical bond (as described herein), or a mechanical bond (e.g., using a fastener, etc.).

As used herein, “carbocycle” means a non-aromatic cyclic ring or ring system containing only carbon atoms in the ring system backbone. When the carbocycle is a ring system, two or more rings may be joined together in a fused, bridged or spiro-connected fashion. Carbocycles may have any degree of saturation, provided that at least one ring in a ring system is not aromatic. Thus, carbocycles include cycloalkyls, cycloalkenyls, and cycloalkynyls. The carbocycle group may have 3 to 20 carbon atoms. Examples of carbocycle rings include cyclopropyl, cyclobutyl, cyclopentyl, cyclohexyl, cyclohexenyl, 2,3-dihydro-indene, bicyclo[2.2.2]octanyl, adamantyl, and spiro[4.4]nonanyl.

As used herein, the term “carboxylic acid” or “carboxyl” as used herein refers to —COOH.

As used herein, “cycloalkylene” means a fully saturated carbocycle ring or ring system that is attached to the rest of the molecule via two points of attachment.

As used herein, “cycloalkenyl” or “cycloalkene” means a carbocycle ring or ring system having at least one double bond, wherein no ring in the ring system is aromatic. Examples include cyclohexenyl or cyclohexene and norbornenyl or norbornene. Also as used herein, “heterocycloalkenyl” or “heterocycloalkene” means a carbocycle ring or ring system with at least one heteroatom in ring backbone, having at least one double bond, wherein no ring in the ring system is aromatic.

As used herein, “cycloalkynyl” or “cycloalkyne” means a carbocycle ring or ring system having at least one triple bond, wherein no ring in the ring system is aromatic. An example is cyclooctyne. Another example is bicyclononyne. Also as used herein, “heterocycloalkynyl” or “heterocycloalkyne” means a carbocycle ring or ring system with at least one heteroatom in ring backbone, having at least one triple bond, wherein no ring in the ring system is aromatic.

The term “epoxy” (also referred to as a glycidyl or oxirane group) as used herein refers to

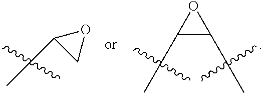

An “epoxy functionalized silsesquioxane” includes a silsesquioxane core that is functionalized with epoxy groups. As used herein, the term “silsesquioxane” refers to a chemical composition that is a hybrid intermediate (RSiO_{1.5}) between that of silica (SiO₂) and silicone (R₂SiO). An example silsesquioxane includes a polyhedral oligomeric silsesquioxane, (commercially available under the tradename POSS® from Hybrid Plastics Inc.). An example of polyhedral oligomeric silsesquioxane can be that described in Kehagias et al., Microelectronic Engineering 86 (2009), pp. 776-778, which is incorporated by reference in its entirety. The composition is an organosilicon compound with the chemical formula [RSiO_{3/2}]ₙ, where n is an even integer ranging from 6 to 14 and at least some of the R groups are epoxy groups.

As used herein, “heteroaryl” refers to an aromatic ring or ring system (i.e., two or more fused rings that share two adjacent atoms) that contain(s) one or more heteroatoms, that is, an element other than carbon, including but not limited to, nitrogen, oxygen and sulfur, in the ring backbone. When the heteroaryl is a ring system, every ring in the system is aromatic. The heteroaryl group may have 5-18 ring members.

As used herein, “heterocycle” means a non-aromatic cyclic ring or ring system containing at least one heteroatom in the ring backbone. Heterocycles may be joined together in a fused, bridged or spiro-connected fashion. Heterocycles may have any degree of saturation provided that at least one ring in the ring system is not aromatic. In the ring system, the heteroatom(s) may be present in either a non-aromatic or aromatic ring. The heterocycle group may have 3 to 20 ring members (i.e., the number of atoms making up the ring backbone, including carbon atoms and heteroatoms). In some examples, the heteroatom(s) are O, N, or S.

The term “hydrazine” or “hydrazinyl” as used herein refers to a —NHNH₂ group.

As used herein, the term “hydrazone” or “hydrazonyl” as used herein refers to a

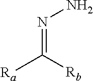

group in which Rₐ and R_{b} are each independently selected from hydrogen, C1-6 alkyl, C2-6 alkenyl, C2-6 alkynyl, C3-7 carbocycle, C6-10 aryl, 5-10 membered heteroaryl, and 5-10 membered heterocycle, as defined herein.

As used herein, “hydroxy” or “hydroxyl” refers to an —OH group.

“Nitrile oxide,” as used herein, means a “RₐC≡N⁺O⁻” group in which Rₐ is defined herein. Examples of preparing nitrile oxide include in situ generation from aldoximes by treatment with chloramide-T or through action of base on imidoyl chlorides [RC(Cl)═NOH] or from the reaction between hydroxylamine and an aldehyde.

“Nitrone,” as used herein, means a

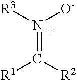

group in which R¹, R², and R³ may be any of the Rₐ and R_{b} groups defined herein, except that R³ is not hydrogen (H).

The term “orthogonally reactive,” when used to describe two resins, means that one of the resins includes functional groups that are capable of reacting with, and thus attaching, a first surface chemistry, and the other of the resins includes functional groups that are incapable of reacting with, and thus are incapable of attaching, the first surface chemistry, but that are capable of reacting with, and thus attaching, a second surface chemistry that is different than the first surface chemistry.

The term “orthogonally etchable or dissolvable,” when used to describe two resins, means that the resins are susceptible to different etch conditions or have different dissolution characteristics. Thus, an etchant or organic solvent that is capable of etching or dissolving one of the resins is not capable of etching or dissolving the other of the resins.

“Surface chemistry,” as used herein, refers to i) primers that are, or are to be, attached to a flow cell surface and that are capable of amplifying a library template strand, or ii) the primers and the polymeric hydrogel that attaches the primers to a substrate.

A “thiol” functional group refers to —SH.

As used herein, the terms “tetrazine” and “tetrazinyl” refer to six-membered heteroaryl group comprising four nitrogen atoms. Tetrazine can be optionally substituted.

“Tetrazole,” as used herein, refer to five-membered heterocyclic group including four nitrogen atoms. Tetrazole can be optionally substituted.

### Flow Cells

An example of a flow cell for simultaneous paired-end sequencing disclosed herein generally comprises a patterned substrate, which includes a base support, two or more resin layers positioned over the base support; and two primer sets respectively attached over the resin layers.

One example of the flow cell 10 is shown in FIG. 1A from a top view. While not shown in the figure, the flow cell 10 may include two patterned substrates bonded together or one patterned substrate bonded to a lid.

Between the two patterned substrates or the one patterned substrate and the lid is a flow channel 11. The two patterned substrates or the one patterned substrate and the lid may be bonded together via a spacer layer (not shown). Thus, each flow channel 11 is defined by the patterned substrate, the spacer layer, and either the lid or the second patterned substrate.

The example shown in FIG. 1A includes eight flow channels 11. While eight flow channels 11 are shown in the figure, it is to be understood that any number of flow channels 11 may be included in the flow cell 10 (e.g., a single flow channel 11, four flow channels 11, etc.). Each flow channel 11 may be isolated from another flow channel 11 so that fluid introduced into one flow channel 11 does not flow into adjacent flow channel(s) 11. Some examples of the fluids introduced into the flow channel 11 may introduce reaction components (e.g., DNA sample, polymerases, sequencing primers, nucleotides, etc.), washing solutions, deblocking agents, etc.

Each flow channel 11 is in fluid communication with an inlet and an outlet (not shown). The inlet and outlet of each flow channel 11 may be positioned at opposed ends of the flow cell 10. The inlets and outlets of the respective flow channels 11 may alternatively be positioned anywhere along the length and width of the flow channel 11 that enables desirable fluid flow.

The inlet allows fluids to be introduced into the flow channel 11, and the outlet allows fluid to be extracted from the flow channel 11. Each of the inlets and outlets is fluidly connected to a fluidic control system (including, e.g., reservoirs, pumps, valves, waste containers, and the like) which controls fluid introduction and expulsion.

The flow channel 11 may have any desirable shape. In an example, the flow channel 11 has a substantially rectangular configuration with curved ends (as shown in FIG. 1A). The length of the flow channel 11 depends, in part, upon the size of the substrate used to form the patterned substrate. The width of the flow channel 11 depends, in part, upon the size of the substrate used to form the patterned substrate, the desired number of flow channels 11, the desired space between adjacent channels 11, and the desired space at a perimeter of the patterned substrate. The spaces between channels 11 and at the perimeter may be sufficient for attachment to a lid (not shown) or another patterned substrate (also not shown).

The depth of the flow channel 11 can be as small as a monolayer thick when microcontact, aerosol, or inkjet printing is used to deposit a separate (spacer) material that defines the flow channel 11 walls. For other examples, the depth of the flow channel 11 can be about 1 μm, about 10 μm, about 50 μm, about 100 μm, or more. In an example, the depth may range from about 10 μm to about 100 μm. In another example, the depth may range from about 10 μm to about 30 μm. In still another example, the depth is about 5 μm or less. It is to be understood that the depth of the flow channel 11 may be greater than, less than or between the values specified above.

In some examples, the spacer layer used to attach the patterned substrate and the lid or the second patterned substrate may be any material that will seal portions of the patterned substrate and the lid or the second patterned substrate. As examples, the spacer layer may be an adhesive, a radiation-absorbing material that aids in bonding, or the like. In some examples, the spacer layer is the radiation-absorbing material, e.g., KAPTON® black. In other examples, the spacer layer is a non-adhering material that is used in conjuction with an adhesive.

The patterned substrate and the lid or the second patterned substrate may be bonded using any suitable technique, such as laser bonding, diffusion bonding, anodic bonding, eutectic bonding, plasma activation bonding, glass frit bonding, or others methods known in the art.

When used, the lid may be any material that is transparent to the excitation light that is directed toward the flow cell 10. In optical detection systems, the lid may also be transparent to the emissions generated from reaction(s) taking place in the flow cell 10. As examples, the lid may include glass (e.g., borosilicate, fused silica, etc.) or a transparent polymer. A commercially available example of a suitable borosilicate glass is D 263®, available from Schott North America Inc. Commercially available examples of suitable polymer materials, namely cyclo olefin polymers, are the ZEONOR® products available from Zeon Specialty Materials, Inc. In some instances, the lid is shaped to form the top of the flow cell 10, and in other instances, the lid is shaped to form both the top of the flow cell as well as sidewalls of the flow channel 11.

The patterned substrate includes a bonding region where it can be sealed to the lid or to the second patterned substrate. The bonding region may be located at the perimeter of each flow channel 11 and at the perimeter of the flow cell 10.

The patterned substrate at least partially defines the flow channel 11. As one example, the patterned substrate may be a multi-layer structure 12 including a base support 14, a first resin layer 16 over the base support 14, an inert layer 18 over the first resin layer 16, and a second resin layer 20 over the inert layer 18, with a plurality of discrete regions 21 defined in/on the multi-layer structure 12, each discrete region 21 including a depression 22 and a pillar 24 adjacent to the depression 22 (as shown in FIG. 1B). In this example, the flow channel 11 is defined by one or more of the resin layers 16, 18, 20, and each discrete region 21 may be separated from each other discrete region 21 by interstitial regions 26. Further in this example, primer sets 30, 32 may be respectively attached within the depression 22 and over the pillar 24. It is to be understood that in this example, the inert layer 18 is selected to be inert at least to the chemical functionalities of the first resin layer 16 and the second resin layer 20. As such, the inert layer 18 may not be universally inert, but is non-reactive under the same conditions used to functionalize the first and second resin layers 16, 20, e.g., with the surface chemistry. Thus, the inert layer 18 is free of primer sets 30, 32.

As another example, the patterned substrate may be a multi-layer structure 12′ including a base support 14, a first resin layer 16′ over the base support 14, a second resin layer 20′ over the first resin layer 16′, and a third resin layer 19 over the second resin layer 20′, with a plurality of multi-depth depressions 22′ (including a shallow portion and a deep portion) defined in the multi-layer structure 12′ (as shown in FIG. 1C). In this example, the flow channel 11 is defined by one or more of the resin layers 16′, 20′, 19, and each multi-depth depression 22′ may be separated from each other multi-depth depression 22′ by interstitial regions 26. Further in this example, primer sets 30, 32 may be respectively attached within the shallow portion and within the deep portion of the multi-depth depressions 22′.

As yet another example, the patterned substrate may be a multi-layer structure 12″ including a base support 14, first resin layer 16″ over the base support 14, and a second resin layer 20″ over the first resin layer 16″, with a multi-height protrusion 28 defined in the multi-layer structure 12″ (as shown in FIG. 1D). In this example, the flow channel 11 is defined by one or more of the resin layers 16″, 20″, and each multi-height protrusion 28 may be separated from each other multi-height protrusion 28 by interstitial regions 26. Further in this example, primer sets 30, 32 may be respectively attached to different regions of the multi-height protrusions 28.

In any of these examples, the depressions 22, the multi-depth depressions 22′, or the multi-height protrusions 28 are in fluid communication with the flow channel 11.

Examples of suitable base supports 14 for the multi-layer structure 12, 12′, or 12″ include epoxy siloxane, glass, modified or functionalized glass, plastics (including acrylics, polystyrene and copolymers of styrene and other materials, polypropylene, polyethylene, polybutylene, polyurethanes, polytetrafluoroethylene (such as TEFLON® from Chemours), cyclic olefins/cyclo-olefin polymers (COP) (such as ZEONOR® from Zeon), polyimides, etc.), nylon (polyamides), ceramics/ceramic oxides, silica, fused silica, or silica-based materials, aluminum silicate, silicon and modified silicon (e.g., boron doped p+ silicon), silicon nitride (Si₃N₄), silicon oxide (SiO₂), tantalum pentoxide (Ta₂O₅) or other tantalum oxide(s) (TaOₓ), hafnium oxide (HfO₂), carbon, metals, resins, or the like.

In an example, the base support 14 may be a circular or rectangular sheet, a panel, a wafer, a die, etc. having a diameter ranging from about 2 mm to about 300 mm, e.g., from about 200 mm to about 300 mm, or may be a rectangular sheet, panel, wafer, die etc. having its largest dimension up to about 10 feet (~3 meters). For example, a die may have a width ranging from about 0.1 mm to about 10 mm. While example dimensions have been provided, it is to be understood that a base support 14 with any suitable dimensions may be used.

The resin layers 16, 16′, 16″ include functional groups that are orthogonally reactive to the functional groups of the resin layers 20, 20′, 20″. As examples, the functional groups of each of the resin layers 16, 16′, 16″ and 20, 20′, 20″ are selected from the group consisting of an amino, an alkynyl, a cycloalkynyl, a cycloalkenyl, a carboxyl, a vinyl, a thiol, an acrylate, an epoxy, and an epoxy siloxane, as long as the desired orthogonality is obtained.

Some examples of suitable resins for the layers 16, 16′, 16″ and 20, 20′, 20″ include a polyhedral oligomeric silsesquioxane resin (e.g., commercially available under the tradename POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin (e.g., poly(propargyl methacrylate) (PPMA)), an amine resin (e.g., poly(allylamine)(PAAm)), and combinations thereof. Some specific examples of pairs of orthogonally reactive resins will now be described.

One example of a pair of orthogonally reactive resins includes resins that exhibit orthogonal silane solution reactivity, i.e., a first of the resins is capable of being solution silanized (i.e., silanized when exposed to a silane in an organic solvent) and a second of the resins is not capable of being solution silanized. In this example, the first resin 16, 16′, 16″ or 20, 20′, 20″ includes silicon-based functional groups that can attach a silane (which can subsequently attach a hydrogel or a primer set 30 or 32), and the second resin 20, 20′, 20″ or 16, 16′, 16″ includes carbon-based functional groups that have no affinity for the silane, but can attach another hydrogel or primer set 32 or 30.

One example of the resin having silicon-based functional groups is an epoxy siloxane that is formed from an epoxy siloxane resin composition including a monomer or cross-linkable copolymer selected from the group consisting of:
i) an epoxy functionalized silsesquioxane (as defined herein);
ii) tetrakis(epoxycyclohexyl ethyl)tetramethyl cyclotetrasiloxane:

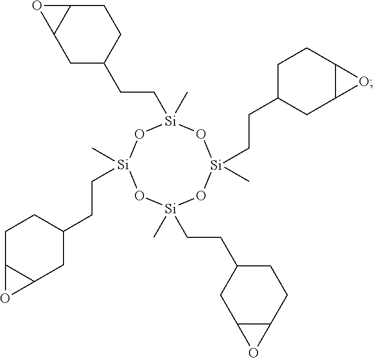 [SMILES: C[Si]1(CCC2CCC3OC3C2)O[Si](C)(CCC2CCC3OC3C2)O[Si](C)(CCC2CCC3OC3C2)O[Si](C)(CCC2CCC3OC3C2)O1]

iii) a copolymer of (epoxycyclohexylethyl)methylsiloxane and dimethylsiloxane:

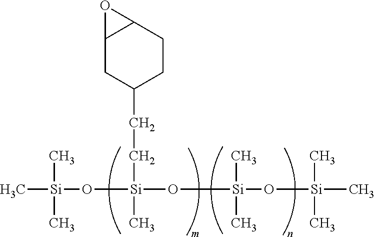

(wherein a ratio of min ranges from 8:92 to 10:90);
iv) 1,3-bis[2-(3,4-epoxycyclohexyl)ethyl] tetramethyl disiloxane:

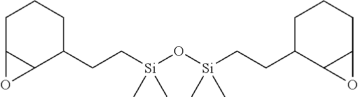 [SMILES: C[Si](C)(CCC1CCCC2OC12)O[Si](C)(C)CCC1CCCC2OC12]

v) 1,3-bis(glycidoxypropyl)tetramethyl disiloxane:

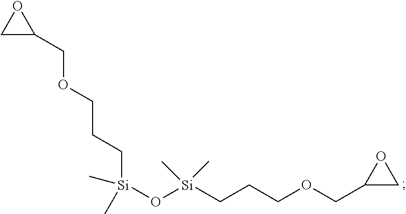 [SMILES: C[Si](C)(CCCOCC1CO1)O[Si](C)(C)CCCOCC1CO1]

and
vi) combinations thereof. The epoxy siloxane resin composition is suitable for solution silanization.

The epoxy siloxane resin composition may include one or more cationically curable species, and thus the resin composition also includes an initiating system, such as a direct photoacid generator or a combination of a photoinitiator and a photoacid generator to initiate curing of the monomer(s) or cross-linkable copolymer(s). Any direct photoacid generator or combination of photoinitiator and photoacid generator may be used that is soluble in the solvent of the resin composition.

Some examples of suitable direct photoacid generators include diaryliodonium hexafluorophosphate, diaryliodonium hexafluoroantimonate, (cumene)cyclopentadienyliron (II) hexafluorophosphate, or combinations thereof.

Some examples of suitable free radical photoinitiators include diphenyl(2,4,6-trimethylbenzoyl)phosphine oxide (DPBAPO), 2-hydroxy-2-methylpropiophenone or a blend of diphenyl(2,4,6-trimethylbenzoyl)phosphine oxide and 2-hydroxy-2-methylpropiophenone, phenylbis(2,4,6-, trimethylbenzoyl)phosphine oxide, ethyl(2,4,6-trimethylbenzoyl)phenylphosphinate, or combinations thereof. Any suitable photoacid generator that is not a direct photoacid generator and that will not undergo undesirable intramolecular interactions with the free radical photoinitiator may be used in combination with the free radical photoinitiator. Examples of suitable (non-direct) photoacid generators may include benzyl, imino ester, conjugated imino ester, spiropyran, teraylene-based, two-photon, or organometallic PAG systems. Specific examples include N-hydroxynaphthalimide triflate, triarylsulfonium hexafluorophosphate salts (mixed), triarylsulfonium hexafluoroantimonate salts (mixed), or the like.

In an example of the epoxy siloxane resin composition, a mass ratio of the monomer(s) or cross-linkable copolymer(s) to the direct photoacid generator ranges from about 99.8:0.2 to 90:10. In another example, a mass ratio of the monomer(s) or cross-linkable copolymer(s) to the free radical photoinitiator/photoacid generator combination ranges from about 99.8:0.2 to 90:10.

Some examples of the epoxy siloxane resin composition may also include a surface additive. The surface additive can adjust the surface tension of the epoxy siloxane resin composition, which can improve the coatability of the diluted resin composition, promote thin film stability, and/or improve leveling. Examples of surface additives include polyacrylate polymers (such as BYK®-350 available from BYK). The amount of the surface additive may be 3 mass % or less, based on the total mass of the epoxy siloxane resin composition.

The epoxy siloxane resin composition may also include a solvent. The solvent may be added to achieve a desired viscosity for the deposition technique being used to apply the epoxy siloxane resin composition. Examples of the epoxy siloxane resin composition viscosity ranges from about 1.75 mPa to about 2.2 mPa (measured at 25° C.). Examples of suitable solvents include propylene glycol monomethyl ether acetate (PGMEA), toluene, dimethyl sulfoxide (DMSO), tetrahydrofuran (THF), etc. In some examples, the solvent is PGMEA. The total solids concentration of the epoxy siloxane resin composition may range from about 15 mass % to about 60 mass %, and the amount of solvent may range from about 40 mass % to about 85 mass %. Not to be bound by any particular theory, but it is believed that the upper limits may be higher depending upon the respective solubility of the solid component(s) in the solvent that is selected.

One example of the resin 20, 20′, 20″ or 16, 16′, 16″ having carbon-based functional groups (which are not solution silanizable) is an organic epoxy resin composition including a monomer or cross-linkable copolymer selected from the group consisting of:
i) trimethylolpropane triglycidyl ether:

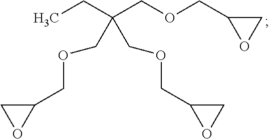 [SMILES: CCC(COCC1CO1)(COCC1CO1)COCC1CO1]

ii) 3,4-epoxycyclohexylmethyl-3,4-epoxycyclo-hexanecarboxylate:

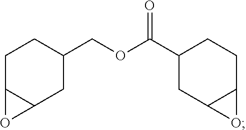 [SMILES: O=C(OCC1CCC2OC2C1)C1CCC2OC2C1]

iii) bis((3,4-epoxycyclohexyl)methyl)adipate:

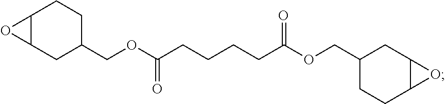 [SMILES: O=C(CCCCC(=O)OCC1CCC2OC2C1)OCC1CCC2OC2C1]

iv) 4-vinyl-1-cyclohexene 1,2-epoxide:

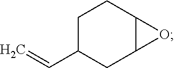

v) vinylcyclohexene dioxide:

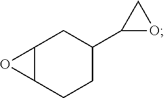

vi) 4,5-epoxytetrahydrophthalic acid diglycidylester:

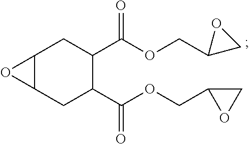 [SMILES: O=C(OCC1CO1)C1CC2OC2CC1C(=O)OCC1CO1]

vii) 1,2-epoxy-3-phenoxypropane:

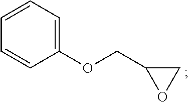 [SMILES: c1ccc(OCC2CO2)cc1]

viii) glycidyl methacrylate:

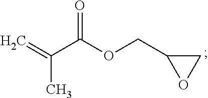

ix) 1,2-epoxyhexadecane:

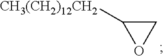

x) poly(ethylene glycol) diglycidylether:

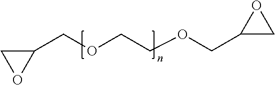

(wherein n ranges from 1 to 100);
xi) pentaerythritol glycidyl ether:

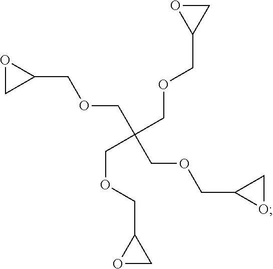 [SMILES: C(OCC(COCC1CO1)(COCC1CO1)COCC1CO1)C1CO1]

xii) diglycidyl 1,2-cyclohexanedicarboxylate:

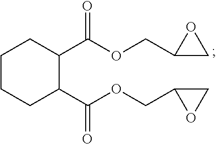 [SMILES: O=C(OCC1CO1)C1CCCCC1C(=O)OCC1CO1]

xiii) tetrahydrophthalic acid diglycidyl ester:

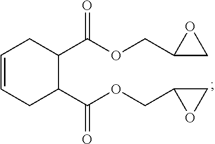 [SMILES: O=C(OCC1CO1)C1CC=CCC1C(=O)OCC1CO1]

and
xiv) combinations thereof.

The organic epoxy resin composition may further include an initiating system selected from the group consisting of a direct photoacid generator and a combination of a free radical photoinitiator and a photoacid generator; and a solvent. In some instances, the organic epoxy resin composition also includes a surface additive.

Any of the direct photoacid generators or the combinations of the free radical photoinitiator and the photoacid generator described herein for the epoxy siloxane resin composition may be used in the organic epoxy resin composition. In an example of the organic epoxy composition, a mass ratio of the monomer(s) or cross-linkable copolymer(s) to i) the direct photoacid generator or ii) the combination of the free radical photoinitiator and the photoacid generator ranges from about 99.8:0.2 to 90:10.

Any of the solvents described herein for the epoxy siloxane resin composition may be used as the solvent in the organic epoxy composition in any of the provided amounts. When included in the organic epoxy composition, the surface additive may be selected from any of the examples provided for the epoxy siloxane resin composition and may be used in any of the provided amounts.

Another example of a pair of orthogonally reactive resins includes a thiol based resin and a non-thiolated resin. In this example, the first resin 16, 16′, 16″ or 20, 20′, 20″ includes thiol-based functional groups that can undergo a base catalyzed Michael addition of an acrylate functionalized hydrogel or primer set 30 or 32 or an alkyne hydrothiolation with an alkyne functionalized hydrogel or primer set 30 or 32, and the second resin 20, 20′, 20″ or 16, 16′, 16″ includes any functional group other than a thiol that can attach another hydrogel or primer set 32 or 30.

One example of a resin composition having the thiol-based chemistry is a thiol-ene resin composition. The thiol-ene resin composition includes from greater than 0 mass % to less than 50 mass %, based on a total monomer content of the thiol-ene resin composition, of an acrylate monomer; from greater than 50 mass % to less than 100 mass % based on the total monomer content of the thiol-ene resin composition, of a thiol monomer selected from the group consisting of:
i) pentaerythritol tetrakis(3-mercaptopropionate):

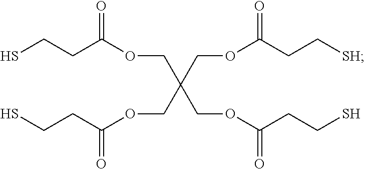 [SMILES: O=C(CCS)OCC(COC(=O)CCS)(COC(=O)CCS)COC(=O)CCS]

ii) 1,4-bis(3-mercaptobutyryloxy)butane; and
iii) trimethylolpropane tris(3-mercaptopropionate);
a radical photoinitiator; an acidic stabilizer, a radical stabilizer, or combinations thereof; an optional surface additive; and a solvent.

Examples of the acrylate monomers for the thiol-ene resin composition include:
i) glycerol dimethacrylate, mixture of isomers:

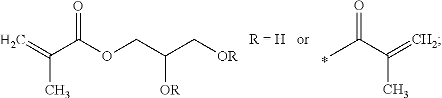

ii) pentaerythritol triacrylate:

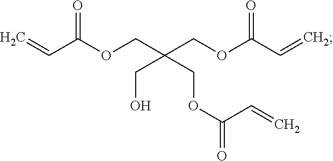 [SMILES: C=CC(=O)OCC(CO)(COC(=O)C=C)COC(=O)C=C]

iii) glycerol 1,3-diglycerolate diacrylate:

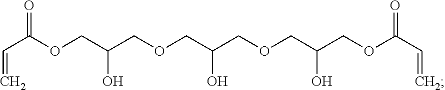 [SMILES: C=CC(=O)OCC(O)COCC(O)COCC(O)COC(=O)C=C]

iv) pentaerythritol tetraacrylate:

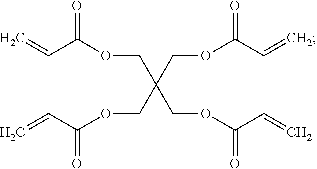 [SMILES: C=CC(=O)OCC(COC(=O)C=C)(COC(=O)C=C)COC(=O)C=C]

and
v) combinations thereof.

The thiol-ene resin composition further includes the radical photoinitiator. Any of the free radical photoinitiators described herein for the epoxy siloxane resin composition may be used as the radical photoinitiator in the thiol-ene resin composition. In these examples, a mass ratio of the total acrylate and thiol monomers to the radical photoinitiator ranges from about 99.8:0.2 to 90:10. In another example, a mass ratio of the total acrylate and thiol monomers to the radical photoinitiator ranges from about 98:2 to 95:5. In any of the examples set forth herein, when lower amounts of the free radical photoinitiator/photoacid generator combination are included, the UV cure time may have to be increased to allow for complete reaction.

The thiol-ene resin composition further includes an acidic stabilizer, a radical stabilizer, or combinations thereof. Examples of suitable acid stabilizers include a substituted phenyl:

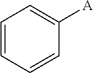

where A is SO₃H, CO₂H, or PO₃H₂; vinyl phosphate:

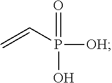

and (2-{[2-(Ethoxycarbonyl) prop-2-en-1-yl]oxy}ethyl)phosphonic acid;

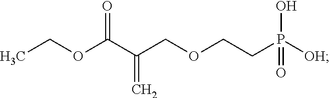

and examples of suitable radical stabilizers include benzene-1,2,3-triol:

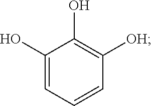

4-methoxyphenol:

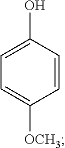

4-tert-butyl-1,2-dihydroxy benzene:

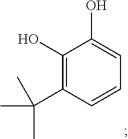

and butylated hydroxytoluene:

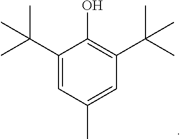 [SMILES: Cc1cc(C(C)(C)C)c(O)c(C(C)(C)C)c1]

A specific example of a suitable acid stabilizer includes phenyl dihydrogen phosphate:

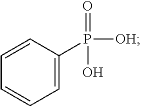

and an examples of a suitable radical stabilizer includes benzene-1,2,3-triol:

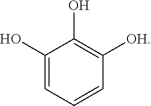

The thiol-ene resin composition may include the surface additive. The surface additive described herein for the epoxy siloxane resin composition may be used as the surface additive in the thiol-ene resin composition in any of the provided amounts.

The thiol-ene resin composition further includes the solvent. Any of the solvents described herein for the epoxy siloxane resin composition may be used as the solvent in the thiol-ene resin composition in any of the provided amounts.

Examples of non-thiolated resins that may be used include any of the resins set forth herein that do not include reactive thiol groups. In one specific example, the thiol-ene resin may be used with the epoxy siloxane resin disclosed herein.

Still another example of a pair of orthogonally reactive resins includes resins that can respectively undergo a Cu(I) click reaction and an amine-NHS (N-hydroxysuccinimide ester) reaction. In this example, the first resin 16, 16′, 16″ or the second resin 20, 20′, 20″ includes alkyne or azide-based functional groups that can respectively attach an azide- or alkyne-functionalized hydrogel or primer set 30 or 32, and the other of the second resin 20, 20′, 20″ or the first resin 16, 16′, 16″ includes an amine that has no affinity for the azide or alkyne, but can attach an NHS-functionalized hydrogel or primer set 30 or 32.

A specific example of the resin that can undergo the Cu(I) click reaction is poly(propargyl methacrylate)(PPMA), and a specific example of the resin that can undergo the amine-NHS reaction is poly(allylamine) (PAAm).

In this example resin pair, each of the resin compositions may include the radical photoinitiator, the additive, and the solvent. Any of the free radical photoinitiators described herein for the epoxy siloxane resin composition may be used as the radical photoinitiator in these resin compositions. In these examples, a mass ratio of the propargyl methacrylate or allylamine monomers to the radical photoinitiator ranges from about 99.8:0.2 to 90:10. The surface additive described herein for the epoxy siloxane resin composition may be used as the surface additive in these resin compositions in any of the provided amounts. Any of the solvents described herein for the epoxy siloxane resin composition may be used as the solvent in these resin compositions in any of the provided amounts.

While several examples of orthogonally reactive resin pairs have been described, it is to be understood that any resins (siloxane-based, carbon-based, thiol-based, etc.) that have orthogonally reactive functional groups may be used together. Some other examples of orthogonally reactive resin pairs are resins that respectively include acetylene functional groups (capable of Cu(I) click with azides) and azide functional groups (capable of Staudinger-ligation or SPAAC cycloaddition), or amine functional groups (capable of NHS reaction) and azide functional groups (capable of Cu(I) click with acetylenes), or thiol functional groups (capable of Michael-addition reactions or thiol-ene coupling) and azide functional groups (capable of Cu(I) click with acetylenes or copper free click chemistry), or carboxyl functional groups (capable of EDC-NHS coupling) and alkene functional groups (capable of thiol-ene coupling), or alkyne functional groups (capable of Cu(I) click with acetylenes or copper free click chemistry) and alkene functional groups (capable of thiol-ene coupling), or terminal alkene functional groups (capable of hydroboration reactions) and internal alkene functional groups (capable of thiol-ene coupling).

The following (meth)acrylate-based resins may be silanized using vapor deposition, spin coating, or other deposition methods, and may be paired with resins that are resistant to silanization or resins that are orthogonally silanizable (capable of attaching different silanes via different chemical reactions). In an example, these (meth)acrylate-based resin compositions comprise or consist of a predetermined mass ratio of a (meth)acrylate cyclosiloxane monomer (e.g., 2,4,6,8-tetramethyl-2,4,6,8-tetrakis[3-acryloyloxypropyl]cyclotetrasiloxane) and a non-siloxane (meth)acrylate based monomer (e.g., glycerol dimethacrylate, mixture of isomers; glycerol 1,3-diglycerolate diacrylate; pentaerythritol triacrylate; pentaerythritol tetraacrylate; bisphenol A glycerolate diacrylate; trimethylpropane triacrylate; 3-(acryloyloxy)-2-hydroxypropyl methacrylate; poly(ethylene glycol) dimethacrylate; ethylene glycol dimethacrylate; and combinations thereof) ranging from about >0:<100 to about 80:20; from 0 mass % to about 10 mass %, based on a total solids content of the resin composition, of an initiator (e.g., a free radical initiator) selected from the group consisting of an azo-initiator, an acetophenone, a phosphine oxide, a brominated aromatic acrylate, and a dithiocarbamate; the surface additive; and the solvent.

The patterned substrate shown in FIG. 1B includes the inert layer 18. The chemical make-up of the inert layer 18 will depend upon the resin layers 16, 20 that are used because the inert layer 18 is to be non-reactive relative to both of the resin layers 16, 20. Examples of the inert layer 18 include a perfluorinated epoxy resin, the organic epoxy resin disclosed herein, silicon dioxide, silicon nitride, tantalum oxide (TaOₓ), copper, or gold. While the organic epoxy resin is disclosed herein as one example of the second resin layer 20, it can alternatively be selected for the inert layer 18 when the carbon-based functionality is not to be used to attach the sequencing/surface chemistry. As one specific example, the organic epoxy resin may be used as the inert layer 18 when the first resin layer 16 is the epoxy siloxane resin and the second resin layer 20 is the thiol-ene resin, or vice-versa.

The patterned substrate shown in FIG. 1C includes the third resin layer 19. Examples of the third resin layer 19 are capable of being imprinted and are also inert relative to the resin layers 16′, 20′. As such, the material of the third resin layer 19 may depend, in part, upon the materials used for the first and second resin layers 16′, 20′. As an example, when one of the first resin layer 16′ or the second resin layer 20′ includes silicon-based functional groups (e.g., that can attach a silane) and the other resin layer 20′ or 16′ is not silanizable, the third layer 19 may be an organic perfluorinated epoxy resin composition. As another example, when one of the first resin layer 16′ or the second resin layer 20′ includes a thiol-based functional group and the other resin layer 20′ or 16′ is non-thiolated, the third resin layer 19 may be a non-thiolated organic epoxy resin composition. As still another example, when the resin layers 16′ or 20′ include functional groups capable of orthogonal click chemistries, the third resin layer 19 may be an organic epoxy resin composition.

Many different layouts of the discrete regions 21 (FIG. 1B), multi-depth depressions 22′ (FIG. 1C), or multi-height protrusions 28 (FIG. 1D) may be envisaged, including regular, repeating, and non-regular patterns. In an example, the discrete regions 21, multi-depth depressions 22′, or multi-height protrusions 28 are disposed in a hexagonal grid for close packing and improved density. Other layouts may include, for example, rectilinear (rectangular) layouts, triangular layouts, and so forth. In some examples, the layout or pattern can be an x-y format in rows and columns. In some other examples, the layout or pattern can be a repeating arrangement of the discrete regions 21, multi-depth depressions 22′, or multi-height protrusions 28, each of which is separated by the interstitial regions 26. In still other examples, the layout or pattern can be a random arrangement of the discrete regions 21, multi-depth depressions 22′, or multi-height protrusions 28, each of which is separated by the interstitial regions 26.

The layout or pattern may be characterized with respect to the density (number) of the discrete regions 21, multi-depth depressions 22′, or multi-height protrusions 28 in a defined area. For example, the discrete regions 21, multi-depth depressions 22′, or multi-height protrusions 28 may be present at a density of approximately 2 million per mm². The density may be tuned to different densities including, for example, a density of about 100 per mm², about 1,000 per mm², about 0.1 million per mm², about 1 million per mm², about 2 million per mm², about 5 million per mm², about 10 million per mm², about 50 million per mm², or more, or less. It is to be further understood that the density can be between one of the lower values and one of the upper values selected from the ranges above, or that other densities (outside of the given ranges) may be used. As examples, a high density array may be characterized as having the discrete regions 21, multi-depth depressions 22′, or multi-height protrusions 28 separated by less than about 100 nm, a medium density array may be characterized as having the discrete regions 21, multi-depth depressions 22′, or multi-height protrusions 28 separated by about 400 nm to about 1 μm, and a low density array may be characterized as having the discrete regions 21, multi-depth depressions 22′, or multi-height protrusions 28 separated by greater than about 1 μm.

The layout or pattern of the discrete regions 21, multi-depth depressions 22′, or multi-height protrusions 28 may also or alternatively be characterized in terms of the average pitch, or the spacing from the center of one discrete region 21, multi-depth depression 22′, or multi-height protrusion 28 to the center of an adjacent discrete region 21, multi-depth depression 22′, or multi-height protrusion 28, or from the right edge of one discrete region 21, multi-depth depression 22′, or multi-height protrusion 28 to the left edge of an adjacent discrete region 21, multi-depth depression 22′, or multi-height protrusion 28 (edge-to-edge spacing). The pattern can be regular, such that the coefficient of variation around the average pitch is small, or the pattern can be non-regular in which case the coefficient of variation can be relatively large. In either case, the average pitch can be, for example, about 50 nm, about 0.1 μm, about 0.5 μm, about 1 μm, about 5 μm, about 10 μm, about 100 μm, or more or less. The average pitch for a particular pattern can be between one of the lower values and one of the upper values selected from the ranges above. In an example, the discrete regions 21, multi-depth depressions 22′, or multi-height protrusions 28 have a pitch (center-to-center spacing) of about 1.5 μm. While example average pitch values have been provided, it is to be understood that other average pitch values may be used.

The size of each discrete region 21, multi-depth depression 22′, or multi-height protrusion 28 may be characterized by at least one of its volume, opening area, top surface area, height, depth, and/or diameter or length and width. For example, the volume can range from about 1×10⁻³ μm³ to about 100 μm³, e.g., about 1×10⁻² μm³, about 0.1 μm³, about 1 μm³, about 10 μm³, or more, or less. For another example, the opening area (e.g., of the depressions 22 or the multi-depth depressions 22′) can range from about 1×10⁻³ μm² to about 100 μm², e.g., about 1×10⁻² μm², about 0.1 μm², about 1 μm², at least about 10 μm², or more, or less. In another example, the top surface area (e.g., of each portion of the multi-height protrusion 28) can range from about 1×10⁻³ μm² to about 100 μm², e.g., about 1×10⁻² μm², about 0.1 μm², about 1 μm², at least about 10 μm², or more, or less. For yet another example, the height (e.g., of the pillars 24 or the multi-height protrusions 28) can range from about 0.1 μm to about 100 μm, e.g., about 0.5 μm, about 1 μm, about 10 μm, or more, or less. For still another example, the depth (e.g., of the depressions 22 or the multi-depth depressions 22′) can range from about 0.1 μm to about 100 μm, e.g., about 0.5 μm, about 1 μm, about 10 μm, or more, or less. For yet another example, the diameter or each of the length and the width of the discrete regions 21, multi-depth depressions 22′, or multi-height protrusions 28 can range from about 0.1 μm to about 100 μm, e.g., about 0.5 μm, about 1 μm, about 10 μm, or more, or less.

The primer sets 30, 32 that are attached at the discrete features 21, or in the multi-depth depressions 22′, or on the multi-height protrusions 28 are related in that one set includes an un-cleavable first primer and a cleavable second primer, and the other set includes a cleavable first primer and an un-cleavable second primer. As examples, the primer sets 30, 32 may include P5 and P7 primers, P15 and P7 primers, or any combination of the PA primers, the PB primers, the PC primers, and the PD primers set forth herein. As examples, the primer sets 30, 32 may include any two PA, PB, PC, and PD primers, or any combination of one PA primer and one PB, PC, or PD primer, or any combination of one PB primer and one PC or PD primer, or any combination of one PC primer and one PD primer.

The primer sets 30, 32 allow a single template strand to be amplified and clustered across both primer sets 30, 32, and also enable the generation of forward and reverse strands on resin layers 16, 20 or 16′, 20′, or 16″, 20″ due to the cleavage groups being present on the opposite primers of the sets 30, 32.

Examples of P5 and P7 primers are used on the surface of commercial flow cells sold by Illumina Inc. for sequencing, for example, on HISEQ™, HISEQX™, MISEQ™, MISEQDX™, MINISEQ™, NEXTSEQ™, NEXTSEQDX™, NOVASEQ™, NOVASEQX™, ISEQ™, GENOME ANALYZER™, and other instrument platforms. The P5 primer (which, in these examples, are cleavable) may be any of the following:

P5 #1: 5′ → 3′
(SEQ. ID. NO. 1)
AATGATACGGCGACCACCGAGAUCTACAC;
P5 #2: 5′ → 3′
(SEQ. ID. NO. 2)
AATGATACGGCGACCACCGAGAnCTACAC

where “n” is alkene-thymidine (i.e., alkene-dT) in the sequence; or

P5 #3: 5′ → 3′
(SEQ. ID. NO. 3)
AATGATACGGCGACCACCGAGAnCTACAC

where “n” is inosine in SEQ. ID. NO. 3.

The P7 primer (which, in these examples, are cleavable) may be any of the following:

P7 #1: 5′ → 3′
(SEQ. ID. NO. 4)
CAAGCAGAAGACGGCATACGAnAT

where “n” is 8-oxoguanine in SEQ. ID. NO. 4;

P7 #2: 5′ → 3′
(SEQ. ID. NO. 5)
CAAGCAGAAGACGGCATACnAGAT

where “n” is 8-oxoguanine in SEQ. ID. NO. 5;

P7 #3: 5′ → 3′
(SEQ. ID. NO. 6)
CAAGCAGAAGACGGCATACnAnAT

where both instances of “n” are 8-oxoguanine in SEQ. ID. NO. 6;

P7 #4: 5′ → 3′
(SEQ. ID. NO. 7)
CAAGCAGAAGACGGCATACGAUAT;
or
P7 #5: 5′ → 3′
(SEQ. ID. NO. 8)
CAAGCAGAAGACGGCATACUAGAT.

The P15 primer (which, in this example, is cleavable) is:

P15: 5′ → 3′
(SEQ. ID. NO. 9)
AATGATACGGCGACCACCGAGAnCTACAC

where “n” is allyl-T (i.e., a thymine nucleotide analog having an allyl functionality).

The other primers (PA-PD, shown as non-cleavable primers) mentioned above include:

PA 5′ → 3′
(SEQ. ID. NO. 10)
GCTGGCACGTCCGAACGCTTCGTTAATCCGTTGAG
PB 5′ → 3′
(SEQ. ID. NO. 11)
CGTCGTCTGCCATGGCGCTTCGGTGGATATGAACT
PC 5′ → 3′
(SEQ. ID. NO. 12)
ACGGCCGCTAATATCAACGCGTCGAATCCGCAACT
PD 5′ → 3′
(SEQ. ID. NO. 13)
GCCGCGTTACGTTAGCCGGACTATTCGATGCAGC

While not shown in the example sequences for PA-PD, it is to be understood that any of these primers may include a cleavage site, such as uracil, 8-oxoguanine, allyl-T, etc. at any point in the strand.

Each of the primers disclosed herein may also include a polyT sequence at the 5′ end of the primer sequence. In some examples, the polyT region includes from 2 T bases to 20 T bases. As specific examples, the polyT region may include 3, 4, 5, 6, 7, or 10 T bases.

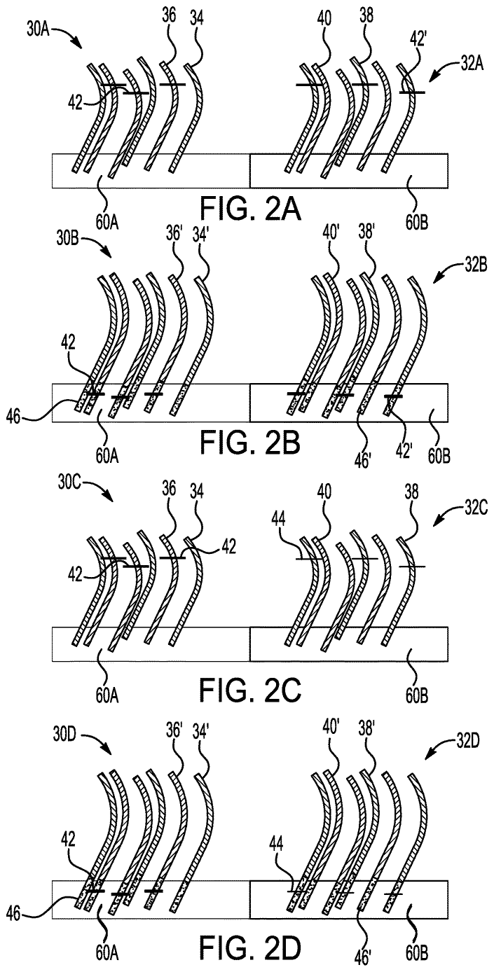

The primers in each set 30, 32 include a terminal functional group that can attach to one of the orthogonally reactive resins 16 or 20, or 16′ or 20′, or 16″ or 20″ or to a hydrogel that is respectively attached to one of the orthogonally reactive resins 16 or 20, or 16′ or 20′, or 16″ or 20″. The terminal functional groups at the 5′ end of each primer may be a component of a linker (e.g., 46, 46′ described in reference to FIG. 2B and FIG. 2D).

FIG. 2A through FIG. 2D depict different configurations of the primer sets 30A, 32A, 30B, 32B, 30C, 32C, and 30D, 32D respectively attached to layers 60A and 60B. In FIG. 2A through FIG. 2D, the reference numerals 60A and 60B may represent any pair of orthogonally reactive resin layers 16 and 20, or 16′ and 20′, or 16″ and 20″, or may respresent any polymeric hydrogels that are respectively attached to the orthogonally reactive resin layers 16 and 20, or 16′ and 20′, or 16″ and 20″.

When polymeric hydrogels are used to attach the primer sets 30A, 32A, 30B, 32B, 30C, 32C, and 30D, 32D to the orthogonally reactive resin layers 16 and 20, or 16′ and 20′, or 16″ and 20″, it is to be understood that one of the hydrogels is functionalized to attach to one of the orthogonally reactive resin layers 16 and 20, or 16′ and 20′, or 16″ and 20″ and the other of the hydrogels is functionalized to attach to the other of the orthogonally reactive resin layers 20 and 16, or 20′ and 16′, or 20″ and 16″. As such, it is to be understood that each individual polymeric hydrogel's affinity for a respective resin layer 16 or 20, or 16′ or 20′, or 16″ or 20″ depends, in part, upon the material and the chemical functionality included in the respective resin layer 16 or 20, or 16′ or 20′, or 16″ or 20″.

The polymeric hydrogels may be any gel material that can swell when liquid is taken up and can contract when liquid is removed, e.g., by drying.

In an example, one of the polymeric hydrogels includes an acrylamide copolymer. Some examples of the acrylamide copolymer are represented by the following structure (I):

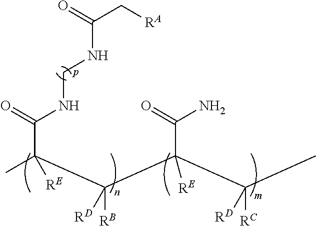

wherein:
   R^{A} is selected from the group consisting of azido, optionally substituted amino, optionally substituted alkene, optionally substituted alkenyl, optionally substituted alkyne, halogen, optionally substituted hydrazone, optionally substituted hydrazine, carboxyl, hydroxy, optionally substituted tetrazole, optionally substituted tetrazine, nitrile oxide, nitrone, sulfate, and thiol;
   R^{B} is H or optionally substituted alkyl;
   R^{C}, R^{D}, and R^{E} are each independently selected from the group consisting of H and optionally substituted alkyl;
   each of the —(CH₂)ₚ— can be optionally substituted;
   p is an integer in the range of 1 to 50;
   n is an integer in the range of 1 to 50,000; and
   m is an integer in the range of 1 to 100,000. In structure (I), the R^{A} group may be selected to attach primers of one of the primer sets 30 or 32 and to attach to one of the orthogonally reactive resin layers 16 or 20, or 16′ or 20′, or 16″ or 20″. The amino groups of structure (I) may, in some instances, also participate in primer attachment and orthogonally reactive resin layer 16 or 20, or 16′ or 20′, or 16″ or 20″.

One specific example of the acrylamide copolymer represented by structure (I) is poly(N-(5-azidoacetamidylpentyl) acrylamide-co-acrylamide, PAZAM.

One of ordinary skill in the art will recognize that the arrangement of the recurring “n” and “m” features in structure (I) are representative, and the monomeric subunits may be present in any order in the polymer structure (e.g., random, block, patterned, or a combination thereof).

The molecular weight of the acrylamide copolymer may range from about 5 kDa to about 1500 kDa or from about 10 kDa to about 1000 kDa, or may be, in a specific example, about 312 kDa.

In some examples, the acrylamide copolymer is a linear polymer. In some other examples, the acrylamide copolymer is a lightly cross-linked polymer.

In other examples, the gel material may be a variation of structure (I). In one example, the acrylamide unit may be replaced with N,N-dimethylacrylamide

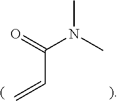

In this example, the acrylamide unit in structure (I) may be replaced with

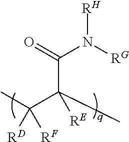

where R^{D}, R^{E}, and R^{F} are each H or a C1-C₆ alkyl, and R^{G} and R^{H} are each a C1-C₆ alkyl (instead of H as is the case with the acrylamide). In this example, q may be an integer in the range of 1 to 100,000. In another example, the N,N-dimethylacrylamide may be used in addition to the acrylamide unit. In this example, structure (I) may include

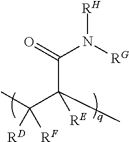

in addition to the recurring “n” and “m” features, where R^{D}, R^{E}, and R^{F} are each H or a C1-C₆ alkyl, and R^{G} and R^{H} are each a C1-C₆ alkyl. In this example, q may be an integer in the range of 1 to 100,000.

As another example of the polymeric hydrogel, the recurring “n” feature in structure (I) may be replaced with a monomer including a heterocyclic azido group having structure (II):

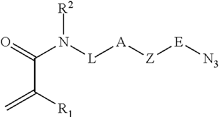

wherein R¹ is H or a C1-C₆ alkyl; R₂ is H or a C1-C₆ alkyl; L is a linker including a linear chain with 2 to 20 atoms selected from the group consisting of carbon, oxygen, and nitrogen and 10 optional substituents on the carbon and any nitrogen atoms in the chain; E is a linear chain including 1 to 4 atoms selected from the group consisting of carbon, oxygen and nitrogen, and optional substituents on the carbon and any nitrogen atoms in the chain; A is an N substituted amide with an H or a C1-C₄ alkyl attached to the N; and Z is a nitrogen containing heterocycle. Examples of Z include 5 to 10 carbon-containing ring members present as a single cyclic structure or a fused structure. Some specific examples of Z include pyrrolidinyl, pyridinyl, or pyrimidinyl.

As still another example, the gel material may include a recurring unit of each of structure (III) and (IV):

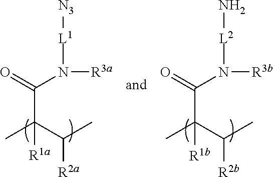

wherein each of R^{1a}, R^{2a}, R^{1b} and R^{2b} is independently selected from hydrogen, an optionally substituted alkyl or optionally substituted phenyl; each of R^{3a} and R^{3b} is independently selected from hydrogen, an optionally substituted alkyl, an optionally substituted phenyl, or an optionally substituted C7-C14 aralkyl; and each L¹ and L² is independently selected from an optionally substituted alkylene linker or an optionally substituted heteroalkylene linker.

In still another example, the acrylamide copolymer is formed using nitroxide mediated polymerization, and thus at least some of the copolymer chains have an alkoxyamine end group. In the copolymer chain, the term “alkoxyamine end group” refers to the dormant species —ONR₁R₂, where each of R₁ and R₂ may be the same or different, and may independently be a linear or branched alkyl, or a ring structure, and where the oxygen atom is attached to the rest of the copolymer chain. In some examples, the alkoxyamine may also be introduced into some of the recurring acrylamide monomers, e.g., at position R^{A} in structure (I). As such, in one example, structure (I) includes an alkoxyamine end group; and in another example, structure (I) includes an alkoxyamine end group and alkoxyamine groups in at least some of the side chains.

Another example of the polymeric hydrogel includes an ester copolymer having an NHS functional group for attachment to the primers of the other primer set 32 or 30 and to the other of the orthogonally reactive resins 20 or 16, or 20′ or 16′, or 20″ or 16″. As another example, the polymeric hydrogel of structure (I) may include the NHS functional group as the R^{A} group.

While some example polymeric hydrogels have been discussed, it is to be understood that the polymer structure may alternatively be a branched polymer, including dendrimers (e.g., multi-arm or star polymers), star-shaped or star-block polymers, and the like. For example, the monomers (e.g., acrylamide, etc.) may be incorporated, either randomly or in block, into the branches (arms) of a dendrimer.

Returning now to FIG. 2A through FIG. 2D, each of the first primer sets 30A, 30B, 30C, and 30D includes an un-cleavable first primer 34 or 34′ and a cleavable second primer 36 or 36′; and each of the second primer sets 32A, 32B, 32C, and 32D includes a cleavable first primer 38 or 38′ and an un-cleavable second primer 40 or 40′.

The un-cleavable first primer 34 or 34′ and the cleavable second primer 36 or 36′ are oligonucleotide pairs, e.g., where the un-cleavable first primer 34 or 34′ is a forward amplification primer and the cleavable second primer 36 or 36′ is a reverse amplification primer or where the cleavable second primer 36 or 36′ is the forward amplification primer and the un-cleavable first primer 34 or 34′ is the reverse amplification primer. In each example of the first primer set 30A, 30B, 30C, and 30D, the cleavable second primer 36 or 36′ includes a cleavage site 42, while the un-cleavable first primer 34 or 34′ does not include a cleavage site 42.

The cleavable first primer 38 or 38′ and the un-cleavable second primer 40 or 40′ are also oligonucleotide pairs, e.g., where the cleavable first primer 38 or 38′ is a forward amplification primer and un-cleavable second primer 40 or 40′ is a reverse amplification primer or where the un-cleavable second primer 40 or 40′ is the forward amplification primer and the cleavable first primer 38 or 38′ is the reverse amplification primer. In each example of the second primer set 32A, 32B, 32C, and 32D, the cleavable first primer 38 or 38′ includes a cleavage site 42′ or 44, while the un-cleavable second primer 40 or 40′ does not include a cleavage site 42′ or 44.

It is to be understood that the un-cleavable first primer 34 or 34′ of the first primer set 30A, 30B, 30C, and 30D and the cleavable first primer 38 or 38′ of the second primer set 32A, 32B, 32C, and 32D have the same nucleotide sequence (e.g., both are forward amplification primers), except that the cleavable first primer 38 or 38′ includes the cleavage site 42′ or 44 integrated into the nucleotide sequence (shown in FIG. 2A and FIG. 2C) or into a linker 46′ attached to the nucleotide sequence (shown in FIG. 2B and FIG. 2D). Similarly, the cleavable second primer 36 or 36′ of the first primer set 30A, 30B, 30C, and 30D and the un-cleavable second primer 40 or 40′ of the second primer set 32A, 32B, 32C, and 32D have the same nucleotide sequence (e.g., both are reverse amplification primers), except that the cleavable second primer 36 or 36′ includes the cleavage site 42 integrated into the nucleotide sequence (as shown in FIG. 2A and FIG. 2C) or into a linker 46 attached to the nucleotide sequence (as shown in FIG. 2B and FIG. 2D).

It is to be understood that when the first primers 34 and 38 or 34′ and 38′ are forward amplification primers, the second primers 36 and 40 or 36′ and 40′ are reverse primers, and vice versa.

The un-cleavable primers 34, 40 or 34′, 40′ may be any primers with a universal sequence for capture and/or amplification purposes, such as the P5 or P15 and P7 primers or any combination of the PA, PD, PC, PD primers (e.g., PA and PB or PA and PD, etc.). In some examples, the P5 or P15 and P7 primers are un-cleavable primers 34, 40 or 34′, 40′ because they do not include a cleavage site 42, 42′, 44. For example, the sequences set forth herein for P5, P15, and P7 (SEQ. ID. NOs. 1 through 9) may be rendered uncleavable by excluding the uracil, alkene-thymidine, or 8-oxoguanine cleavage sites. It is to be understood that any suitable universal sequence can be used as the un-cleavable primers 34, 40 or 34′, 40′.

Examples of cleavable primers 36, 38 or 36′, 38′ include the P5, P15, and P7 primers or other universal sequence primers (e.g., the PA, PB, PC, PD primers) with the respective cleavage sites 42, 42′, 44 incorporated into the respective nucleic acid sequences (e.g., FIG. 2A and FIG. 2C), or into a linker 46′, 46 that attaches the cleavable primers 36, 38 or 36′, 38′ to the respective layers 60A, 60B (FIG. 2B and FIG. 2D). Examples of suitable cleavage sites 42, 42′, 44 include enzymatically cleavable nucleobases or chemically cleavable nucleobases, modified nucleobases, or linkers (e.g., between nucleobases), as described herein. As examples, the sequences set forth herein for PA, PB, PC, and PD (SEQ. ID. NOs. 10 through 13) may be rendered cleavable by including any example of the cleavage sites 42, 42′, 44 set forth herein. It is to be understood that any suitable universal sequence can be used as the cleavable primers 36, 38 or 36′, 38′.

Each primer set 30A and 32A or 30B and 32B or 30C and 32C or 30D and 32D is attached to a respective layer 60A, 60B. When the layers 60A and 60B are the orthogonally reactive resin layers 16 and 20, or 16′ and 20′, or 16″ and 20″, the primer sets 30A and 32A or 30B and 32B or 30C and 32C or 30D and 32D include different functional groups that can selectively react with the desired resin layer 16 or 20, or 16′ or 20′, or 16″ or 20″. When the layers 60A and 60B are different polymeric hydrogels that are introduced to the patterned substrates prior to primer grafting, the primer sets 30A and 32A or 30B and 32B or 30C and 32C or 30D and 32D include different functional groups that can selectively react with the desired polymeric hydrogel. When the layers 60A and 60B are pre-grafted polymeric hydrogels, the primer sets 30A and 32A or 30B and 32B or 30C and 32C or 30D and 32D may include the same functional groups or different functional groups because they are attached to the desired polymeric hydrogel before it is attached to the desired resin layer 16 or 20, or 16′ or 20′, or 16″ or 20″ of the patterned substrate.

While not shown in FIG. 2A through FIG. 2D, it is to be understood that one or both of the primer sets 30A, 30B, 30C, 30D or 32A, 32B, 32C or 32D may also include a PX primer for capturing a library template seeding molecule. As one example, PX may be included with the primer set 30A, 30B, 30C, 30D, but not with primer set 32A, 32B, 32C or 32D. As another example, PX may be included with the primer set 30A, 30B, 30C, 30D and with the primer set 32A, 32B, 32C or 32D. The density of the PX motifs should be relatively low in order to minimize polyclonality at each discrete region 21, or within each multi-depth 22′, or on each multi-height protrusion 28.

The PX capture primer may be:

PX 5′ → 3′
(SEQ. ID. NO. 14)
AGGAGGAGGAGGAGGAGGAGGAGG

FIG. 2A through FIG. 2D depict different configurations of the primer sets 30A, 32A, 30B, 32B, 30C, 32C, and 30D, 32D respectively attached to two layers 60A, 60B. More specifically, FIG. 2A through FIG. 2D depict different configurations of the primers 34, 36 or 34′, 36′ and 38, 40 or 38′, 40′ that may be used.

In the example shown in FIG. 2A, the primers 34, 36 and 38, 40 of the primer sets 30A and 32A are directly attached to a respective layer 60A, 60B, for example, without a linker 46, 46′. The layer 60A may have surface functional groups that can immobilize the terminal groups at the 5′ end of the primers 34, 36. Similarly, the layer 60B may have surface functional groups that can immobilize the terminal groups at the 5′ end of the primers 38, 40. In one example, the immobilization chemistry between the layer 60A and the primers 34, 36, and the immobilization chemistry between the layer 60B and the primers 38, 40 may be different so that the primers 34, 36 or 38, 40 selectively attach to the desirable layer 60A or 60B. For example, the layer 60A may have an azido silane thereon that can graft alkyne terminated primers (e.g., 34, 36 or 34′, 36′), and the layer 60B may have an alkyne functionalized silane thereon that can graft azide terminated primers (e.g., 38, 40 or 38′, 40′). For another example, the layer 60A may have an amine functionalized silane thereon that can graft NHS-ester terminated primers (e.g., 34, 36 or 34′, 36′), and the layer 60B may have a maleimide silane thereon that can graft thiol terminated primers (e.g., 38, 40 or 38′, 40′).

In this example, immobilization may be by single point covalent attachment or by a strong non-covalent attachment to the respective layer 60A, 60B at the 5′ end of the respective primers 34 and 36 or 34′ and 36′ or 38 and 40, or 38′ and 40′.

Examples of terminated primers that may be used include an alkyne terminated primer, a tetrazine terminated primer, an azido terminated primer, an amino terminated primer, an epoxy or glycidyl terminated primer, a thiophosphate terminated primer, a thiol terminated primer, an aldehyde terminated primer, a hydrazine terminated primer, a phosphoramidite terminated primer, and a triazolinedione terminated primer. In some specific examples, a succinimidyl (NHS) ester terminated primer may be reacted with an amine at a surface of the layer 60A, 60B, an aldehyde terminated primer may be reacted with a hydrazine at a surface of the layer 60A, 60B, or an alkyne terminated primer may be reacted with an azide at a surface of the layer 60A, 60B, or an azide terminated primer may be reacted with an alkyne or DBCO (dibenzocyclooctyne) at a surface of the layer 60A, 60B, or an amino terminated primer may be reacted with an activated carboxylate group or NHS ester at a surface of the layer 60A, 60B, or a thiol terminated primer may be reacted with an alkylating reactant (e.g., iodoacetamine or maleimide) at a surface of the layer 60A, 60B, or a phosphoramidite terminated primer may be reacted with a thioether at a surface of the resin layer 60A, 60B.

Also, in the example shown in FIG. 2A, the cleavage site 42, 42′ of each of the cleavable primers 36, 38 is incorporated into the sequence of the primer. In this example, the same type of cleavage site 42, 42′ is used in the cleavable primers 36, 38 of the respective primer sets 30A, 32A. As an example, the cleavage sites 42, 42′ are uracil bases, and the cleavable primers 36, 38 are P5U (SEQ. ID. NO. 1) and P7U (e.g., SEQ. ID. NO. 7 or 8). In this example, the un-cleavable primer 34 of the oligonucleotide pair 34, 36 may be P7 (e.g., SEQ. ID. NO. 4, 5 or 6 without 8-oxoguanine or SEQ. ID. NO. 7 or 8 without uracil), and the un-cleavable primer 40 of the oligonucleotide pair 38, 40 may be P5 (e.g., SEQ. ID. NO. 1, 2, or 3 without uracil or alkene-thymidine or inosine). Thus, in this example, the first primer set 30A includes P7, P5U and the second primer set 32A includes P5, P7U. The primer sets 30A, 32A have opposite linearization chemistries, which, after amplification, cluster generation, and linearization, allows forward template strands to be formed on one layer 60A or 60B and reverse strands to be formed on the other layer 60A or 60B.

In the example shown in FIG. 2B, the primers 34′, 36′ and 38′, 40′ of the primer sets 30B and 32B are attached to the layers 60A, 60B, for example, through linkers 46, 46′. The layer 60A may have surface functional groups that can immobilize the linker 46 at the 5′ end of the primers 34′, 36′. Similarly, the layer 60B may have surface functional groups that can immobilize the linker 46′ at the 5′ end of the primers 38′, 40′. In one example, the immobilization chemistry for the layer 60A and the linkers 46 and the immobilization chemistry for the layer 60B and the linkers 46′ may be different so that the primers 34′, 36′ or 38′, 40′ selectively graft to the desirable layer 60A or 60B.

Examples of suitable linkers 46, 46′ may include nucleic acid linkers (e.g., 10 nucleotides or less) or non-nucleic acid linkers, such as a polyethylene glycol chain, an alkyl group or a carbon chain, an aliphatic linker with vicinal diols, a peptide linker, etc. An example of a nucleic acid linker is a polyT spacer, although other nucleotides can also be used. In one example, the spacer is a 6T to 10T spacer. The following are some examples of nucleotides including non-nucleic acid linkers (where B is the nucleobase and “oligo” is the primer):

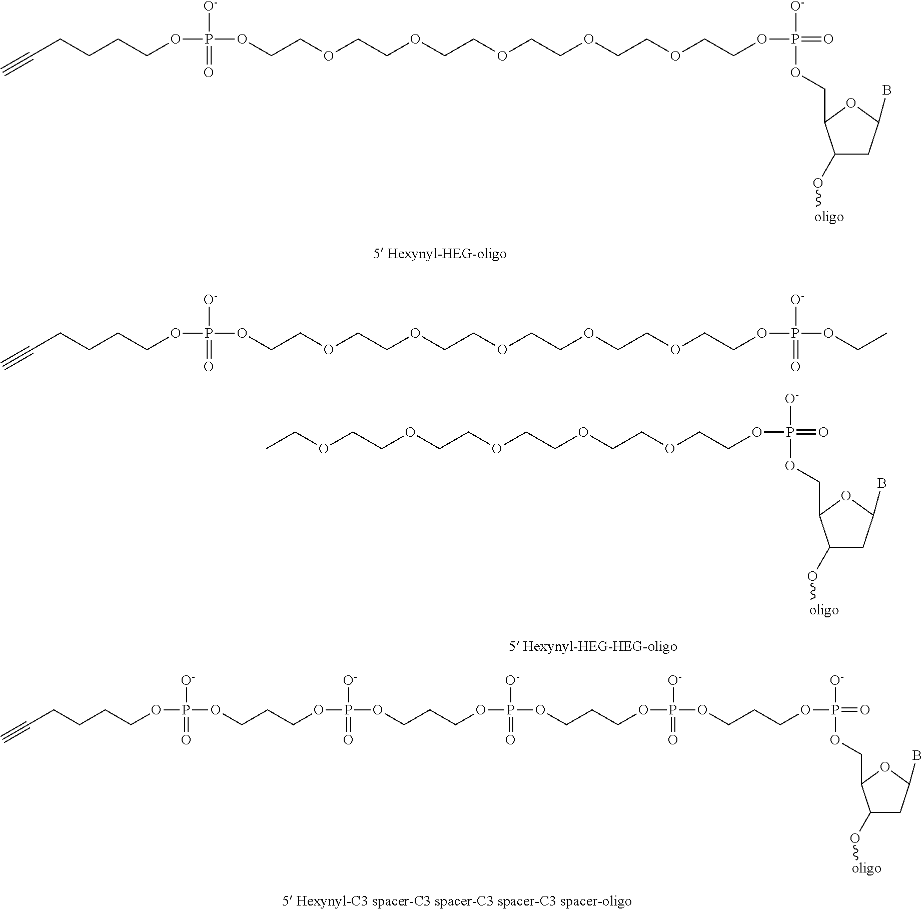

In the example shown in FIG. 2B, the primers 34′, 38′ have the same sequence (e.g., P5) and the same or different linkers 46, 46′. The primer 34′ is un-cleavable (no uracil or alkene-thymidine or inosine), whereas the primer 38′ includes the cleavage site 42′ incorporated into the linker 46′. Also in this example, the primers 36′, 40′ have the same sequence (e.g., P7) and the same or different linkers 46, 46′. The primer 40′ in un-cleavable (no 8-oxoguanine or uracil), and the primer 36′ includes the cleavage site 42 incorporated into the linker 46. The same type of cleavage site 42, 42′ is used in the linker 46, 46′ of each of the cleavable primers 36′, 38′. As an example, the cleavage sites 42, 42′ may be uracil bases that are incorporated into nucleic acid linkers 46, 46′. The primer sets 30B, 32B have opposite linearization chemistries, which, after amplification, cluster generation, and linearization, allows forward template strands to be formed on one layer 60A or 60B and reverse strands to be formed on the other layer 60A or 60B.

The example shown in FIG. 2C is similar to the example shown in FIG. 2A, except that different types of cleavage sites 42, 44 are used in the cleavable primers 36, 38 of the respective primer sets 30C, 32C. As examples, two different enzymatic cleavage sites may be used, two different chemical cleavage sites may be used, or one enzymatic cleavage site and one chemical cleavage site may be used. Examples of different cleavage sites 42, 44 that may be used in the respective cleavable primers 36, 38 include any combination of the following: vicinal diol, uracil, allyl ether, disulfide, restriction enzyme site, and 8-oxoguanine.

The example shown in FIG. 2D is similar to the example shown in FIG. 2B, except that different types of cleavage sites 42, 44 are used in the linkers 46, 46′ attached to the cleavable primers 36′, 38′ of the respective primer sets 30D, 32D. Examples of different cleavage sites 42, 44 that may be used in the respective linkers 46, 46′ attached to the cleavable primers 36′, 38′ include any combination of the following: vicinal diol, uracil, allyl ether, disulfide, restriction enzyme site, and 8-oxoguanine.

In the examples shown in FIG. 2B and FIG. 2D, it is to be understood that the sequences of the primers 36′, 38′ do not include a cleavage site 42, 42′, 44 because they are incorporated into the linkers 46, 46′.

In any of the examples, the attachment of the primers 34, 36 and 38, 40 or 34′, 36′ and 38′, 40′ to the layers 60A, 60B leaves a template-specific portion of the primers 34, 36 and 38, 40 or 34′, 36′ and 38′, 40′ free to anneal to its cognate template and the 3′ hydroxyl group free for primer extension.

Different methods that may be used to generate flow cells 10 are disclosed herein. The various methods will now be described.

### Method of Forming a Flow Cell Including Discrete Regions

An example method of forming a multi-layer stack 48 (that is to be used in forming a flow cell 10 having one or more discrete active region(s)) is depicted in FIG. 3A through FIG. 3C. This example method includes applying a first resin layer 16 over a base support 14 (FIG. 3A), applying an inert layer 18 over the first resin layer 16 (FIG. 3B), and applying a second resin layer 20 over the inert layer 18 (FIG. 3C).

Suitable techniques for depositing the layers 16, 18, 20 include chemical vapor deposition, dip coating, dunk coating, spin coating, spray coating, puddle dispensing, ultrasonic spray coating, doctor blade coating, aerosol printing, screen printing, microcontact printing, etc.

The resin layer 16 may be deposited and cured before the inert layer 18 is applied thereon. Curing may be performed by exposure to actinic radiation or heat, depending upon the chemical make-up of the resin layer 16.

After the resin layer 16 is applied to the base support 14, it may be soft baked to remove excess solvent. The soft bake may take place at a lower temperature than is used for curing (e.g., ranging from about 50° C. to about 150° C.) and for a time ranging from greater than 0 seconds to about 3 minutes. In an example, the soft bake time ranges from about 30 seconds to about 2.5 minutes.

Curing may be accomplished by exposing the applied resin composition to incident light at an energy dose ranging from about 0.5 J to about 20 J for 30 seconds or less. The incident light may be actinic radiation, such as ultraviolet (UV) radiation. In one example, the majority of the UV radiation emitted may have a wavelength of about 365 nm.

In some examples disclosed herein, the energy exposure promotes decomposition of the direct photoacid generator into an acid that initiates polymerization and/or cross-linking of the monomers in the resin composition. In some instances, the incident light exposure time may be 120 seconds or less. In other instances, the incident light exposure time may be 30 seconds or less. In still other instances, the incident light exposure time may be about 5 seconds. In other examples disclosed herein, the energy exposure causes the photoinitiator to generate free radicals, which promote decomposition of the photoacid generator into an acid that initiates polymerization and/or cross-linking of the monomers in the resin composition. With the effective extent of curing brought on by this mechanism, the incident light exposure time may be 120 seconds or less. In some instances, the incident light exposure time may be 30 seconds or less. In still other instances, the incident light exposure time may be about 5 seconds.

The curing process may include a single UV exposure stage. After curing, the resin layer 16 is formed.

In some instances, it may be desirable to perform a post-curing bake process. If performed, the post-curing bake may take place at a temperature ranging from about 150° C. to about 250° C. for a time ranging from about 1 minute to about 2 minutes.

The inert layer 18 may be deposited using any of the techniques set forth herein. When the inert layer 18 is the perfluorinated epoxy or the organic epoxy, the deposited composition may be cured to form the inert layer 18. Inorganic materials, such as silicon dioxide, copper, etc. may be dried after being deposited.

The resin layer 20 may be deposited on the inert layer 18 using any suitable deposition technique disclosed herein. The deposition of the resin layer 20 forms the multi-layer stack 48 shown in FIG. 3C, and this layer 20 is patterned to form the initial discrete regions 21′, which will be described in reference to FIG. 4A through FIG. 4C.

Turning now to FIG. 4A through FIG. 4C, an example of the method shown in FIG. 3A through FIG. 3C continues by contacting the multi-layer stack 48 (including the base support 14, the first resin layer 16 over the base support 14, the inert layer 18 over the first resin layer 16, and the second resin layer 20 over the inert layer 18) with a working stamp 130 to define an initial discrete region 21′ in the second resin layer 20 of the multi-layer stack 48, wherein: the initial discrete region 21′ includes a concave region 116 and a convex region 118 that are directly adjacent to one another; the first resin layer 16 of the multi-layer stack 48 comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; the second resin layer 20 of the multi-layer stack 48 comprises a having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and the inert layer 18 of the multi-layer stack 48 comprises a polymer that is inert to the first and second functional groups (FIG. 4A); etching the multi-layer stack 48 having the plurality of initial discrete regions 21′ defined therein i) at the concave region 116 to form a depression 22 through the inert layer 18 and in the first resin layer 16, ii) at the convex region 118 to form a pillar 24 in the second resin layer 20, and iii) to expose a surface of the inert layer 18 around the (final) discrete region 21 (FIG. 4B); selectively attaching a first primer set 30 in each depression 22 (FIG. 4C); and selectively attaching a second primer set 32 over each pillar 24 (FIG. 4C).

As one example, one of the first resin layer 16 or the second resin layer 20 is the organic epoxy resin composition disclosed herein, and the other of the first resin layer 16 or the second resin layer 20 is the siloxane based resin composition disclosed herein. As another example, one of the first resin layer 16 or the second resin layer 20 may be the thiol-ene resin composition described herein (or another thiol-based resin), and the other of the first resin layer 16 or the second resin layer 20 may be non-thiolated.

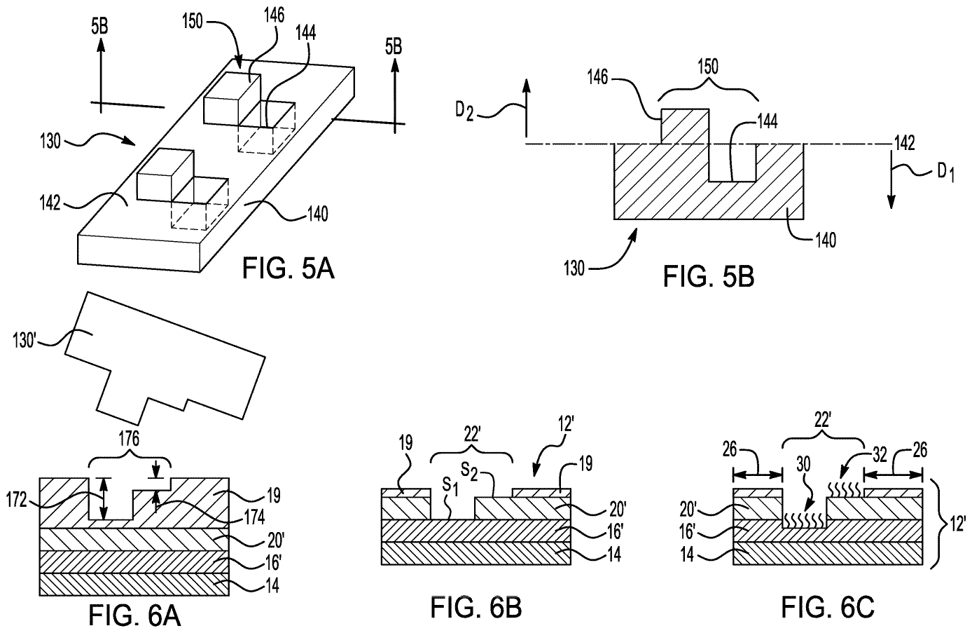

It is to be understood that the working stamp 130 is pressed into the second resin layer 20 (e.g., while the second resin layer 20 is soft, i.e., before curing). This creates an imprint of the working stamp 130 features in the second resin layer 20. After the working stamp 130 is pressed into the second resin layer 20, the layer 20 may be cured while the working stamp 130 is in place. Curing may be accomplished by exposure to actinic radiation or heat. The features of the working stamp 130 are depicted in FIG. 5A and FIG. 5B, and these features will now be described.

As shown in FIG. 5A and FIG. 5B, the working stamp 130 includes a substrate 140 having a planar surface 142; and a plurality of discrete features 150 formed in the substrate 140 and separated from one another by the planar surface 142, each of the discrete features 150 including: a concave portion 144 defined in the substrate 140 and extending in a first direction D₁ from the planar surface 142; and a convex portion 146 defined in the substrate 150 and extending in a second direction D₂ from the planar surface 142; wherein the second direction D₂ is opposed to the first direction D₁, and the concave and convex portions 144, 146 are directly adjacent to each other.

The working stamp 130 may include any suitable material, such as a polymeric material, a metallic material, a ceramic material, or any other material that is suitable for patterning the resin layer 20. As an example, the working stamp 130 includes a polyurethane material. As another example, the working stamp 130 includes polydimethylsiloxane (PDMS). As still another example, the working stamp 130 includes cured FOMBLIN® MD700, commercially available from Acota Ltd.

The discrete features 150 of the working stamp 130 are negative replicas of the initial discrete regions 21′ that are to be patterned in second resin layer 20. As such, the dimensions of the concave portion 144 and the convex portion 146 of the working stamp 130 respectively correspond to the desired dimensions of the concave region 116 or the convex region 118 (that are to be formed in the second resin layer 20) depicted in FIG. 4A. The dimensions of the concave region 116 and the convex region 118 are within the same ranges set forth herein for the depression 22 and pillar 24, with the caveat that the depth and the height of the depression 22 and pillar 24 may be increased relative to the concave region 116 and the convex region 118, respectively, as a result the etching processes described in reference to FIG. 4B.

Returning now to FIG. 4A, after curing, the working stamp 130 is released (as shown) from the patterned resin layer 20. This creates an initial discrete region 21′ including the concave region 116 and the convex region 118 in the second resin layer 20 of the multi-layer stack 48. While FIG. 4A depicts the formation of a single initial discrete region 21′ in the second resin layer 20 of the multi-layer stack 48, it is to be understood that a plurality of initial discrete regions 21′ (each including a concave region 116 and a convex region 118) may be formed in the second resin layer 20.

As shown in FIG. 4B, the example method proceeds by etching the multi-layer stack 48 at the concave region 116 to form a depression 22 through the inert layer 18 and through a portion of the first resin layer 16, such that a remaining portion of the first resin layer 16 forms a bottom surface of the depression 22. It is to be understood that during this process, portions of the second resin layer 20 and the inert layer 18 within the concave region 116 are completely removed from the multi-layer stack 48.

As further shown in FIG. 4B, the method includes etching the multi-layer stack 48 at each of the convex regions 118 to form the pillar 24 in the second resin layer 20. It is to be further understood that during this process, at least some of the second resin layer 20 (e.g., the material of the second resin layer 20 outside of the convex region 118) is etched and completely removed from the multi-layer stack 48, while a portion of the second resin layer 20 that forms the pillar 24 within the convex region 118 remains intact.

To etch the multi-layer stack 48, a series of etching processes is performed. At the outset, an etchant is selected to partially etch the second resin layer 20. The second resin layer 20 may be etched using a dry etching process, such as an anisotropic oxygen plasma, a fluorinated plasma, or a mixture of 90% CF₄ and 10% O₂ plasma. In one specific example, the second resin layer 20 is the photocured epoxy siloxane resin, and is etched with a fluorinated plasma (e.g., CF₄ or CF₄/SF₆).

During this etching process, the exposed surface of the second resin layer 20 is etched away until the inert layer 18 is exposed at the concave region 116. The inert layer 18 acts as an etch stop during this etching process, and thus once the inert layer 18 is exposed at the concave region 116, etching is stopped. This etching process decreases the height of the second resin layer 20 at the convex region 118 and at those areas surrounding the initial discrete region 21′. The decrease in height is equivalent to the thickness of the portion of the second resin layer 20 that is present in the concave region 116 prior to etching.

Once the inert layer 18 is exposed at the concave region 116, the exposed portion of the inert layer 18 may then be removed via an etching process that is selective to the inert layer 18 (i.e., the remaining second resin layer 20 will not be affected). Examples of suitable etching techniques for the inert layer 18 include dry etching, or wet etching using an etchant. The etchant(s) that is/are used may depend, in part, upon the materials used for the inert layer 18 and the second resin layer 20, as it is desirable to remove the exposed inert layer 18 without removing the exposed second resin layer 20. As examples, when the inert layer 18 includes gold, the etchant used may be iodine or a solution containing iodine; when the inert layer 18 includes copper, the etchant used may be FeCl₃; when the inert layer 18 includes silicon dioxide, the etchant used may be hydrofluoric acid (HF); when the inert layer 18 includes silicon nitride, the etchant used may be phosphoric acid; and when the inert layer 18 includes a perfluorinated resin material, the inert layer 18 may be exposed to anisotropic etching using air or 100% O₂ plasma. It is to be understood that the dry etching of the inert layer 18 may use the same ions as the dry etching of the second resin layer 20 at a different ratio so that the second resin layer 20 is not removed.

Once the first resin layer 16 is exposed at the concave region 116, portions of the first resin layer 16 and portions of the second resin layer 20 are removed to i) form the depression 22, ii) form the pillar 24, and iii) expose the interstitial regions 26.

When the first and second resin layers 16, 20 are etchable via the same etchant, these layers 16, 20 can be etched simultaneously. It is to be understood that the portions of the second resin layer 20 that overlie the areas that are to become the interstitial regions 26 will be removed (i.e., the inert layer 18 will be exposed at these portions), and a corresponding thickness of the second resin layer 20 will be removed from the convex region 118, thus forming the pillar 24. Simultaneously, the same thickness of the exposed first resin layer 16 will be removed, thus forming the depression 22. It is to be understood that the portion of the first resin layer 16 that is removed is less than the total thickness of that layer 16 so that the bottom surface of the depression 22 is made up of the first resin layer 16. Any of the etchants set forth herein for the second resin layer 20 may be used in this example, as long as both layers 16, 20 are susceptible to the etchant.

When the first and second resin layers 16, 20 are orthogonally etchable (i.e., etchable via different etchants), these layers 16, 20 will be etched sequentially in any desired order. For example, the portions of the second resin layer 20 that overlie the areas that are to become the interstitial regions 26 can be removed (i.e., the inert layer 18 will be exposed at these portions), and a corresponding thickness of the second resin layer 20 will be removed from the convex region 118, thus forming the pillar 24. Prior to or after this etching process, a desired thickness of the exposed first resin layer 16 will be removed, thus forming the depression 22. It is to be understood that the portion of the first resin layer 16 that is removed is less than the total thickness of that layer 16 so that the bottom surface of the depression 22 is made up of the first resin layer 16. Any of the etchants set forth herein for the second resin layer 20 may be used in this example, and will be selected depending upon the chemical make-up of the resin layers 16, 20. In one example, the second resin layer 20 is the organic epoxy resin described herein and can be etched anisotropically using air or 100% O₂ plasma, and the first resin layer 16 is the thiol-ene resin described herein and can be etched using CF₄ plasma or using a mixture of 90% CF₄ and 10% O₂ plasma.

The etching processes form the patterned substrate, which in this example is the multi-layer structure 12 (see FIG. 4B).

Following the patterning and the etching of the multi-layer stack 48, the primer sets 30, 32 may then be respectively attached within the depression 22 and over the pillar 24 (see FIG. 4C). During this process, the primers 34, 36 or 34′, 36′ (not labeled in FIG. 4C) of the primer set may be grafted to the first resin layer 16 within the depression 22, or to a polymeric hydrogel that has been applied thereon (polymeric hydrogel not shown). Further during this process, the primers 38, 40 or 38′, 40′ (not labeled in FIG. 4C) of the primer set 32 may be grafted to the second resin layer 20 that forms the pillar 24, or to the polymeric hydrogel applied thereon (not shown). Alternatively, the primers 34, 36 or 34′, 36′ of the primer set 30 may be grafted to the second resin layer 20 that forms the pillar 24, and the primers 38, 40 or 38′, 40′ of the primer set 32 may be grafted to the first resin layer 16 within the depression 22. Any of the exposed surfaces of the first and second resin layers 16, 20 may have primers 34, 36 or 34′, 36′ or 38, 40 or 38′, 40′ grafted thereto.

When the polymeric hydrogels are used, the first polymeric hydrogel may be applied and selectively attached to the first resin layer 16 using any suitable deposition technique. The attachment between the first polymeric hydrogel and the first resin layer 16 is selective due to the functional groups being selected to attach to one another. Because the first polymeric hydrogel does not attach to the inert layer 18 or the second resin layer 20, the first polymeric hydrogel may be easily removed (e.g., via sonication, washing, wiping, etc.) from the inert layer 18 and the second resin layer 20. The second polymeric hydrogel may be selectively applied and selectively attached to the second resin layer 20 using any suitable deposition technique under high ionic strength conditions (e.g., in the presence of 10×PBS, NaCl, KCl, etc.). Not only are the functional groups selected to attach to one another, but the high ionic strength conditions keep the second polymeric hydrogel from depositing on or adhering to the first polymeric hydrogel.

As examples, grafting of the primer sets 30 and 32 may be accomplished by flow through deposition (e.g., using a temporarily bound lid), dunk coating, spray coating, puddle dispensing, or by another suitable method. Each of these example techniques may utilize a primer solution or mixture, which may include the primer set 30 or 32, water, a buffer, and a catalyst. With any of the grafting methods, one of primer set 30 or 32 reacts with reactive groups of one of the first resin layer 16 or the first polymeric hydrogel thereon (within the depression 22), while having no affinity for functional groups of the second resin layer 20 or the second polymeric hydrogel thereon. Further, the other of the primer set 32 or 30 reacts with reactive groups of the second resin layer 20 (forming the pillar 24) or the second polymeric hydrogel thereon, while having no affinity for the functional groups of first resin layer 16 or the first polymeric hydrogel thereon. As such, one primer set 30 or 32 may be grafted over the pillar 24, and the other primer set 30 or 32 may be grafted within the depression 22. Grafting may thus occur simultaneously or sequentially.

While not shown in FIG. 4A through FIG. 4C, in some examples, prior to selectively attaching the first primer set 30 in the depression 22 and attaching the second primer set 32 over the pillar 24, the method further comprises exposing the multi-layer structure 12 to a silane in an organic solvent, thereby selectively silanizing a surface of one of (i) the first resin layer 16 within the depression 22, or (ii) the second resin layer 20 that forms the pillar 24. A suitable example of the silane in the organic solvent is trimethoxy-silane. Another suitable example of the silane in the organic solvent is norbornene silane in acetonitrile. As described, the first and second functional groups of the first and second resin layers 16, 20 may be controlled so that the first and second resin layers 16, 20 are selectively silanized or activated. In these examples, one of the first resin layer 16 or the second resin layer 20 is functionalized with the silicon-based functional group and is susceptible to solution silanization, and the other of the first resin layer 16 or the second resin layer 20 is functionalized with a carbon-based functional group and has no affinity for the silane. As such, in these examples, one of the first resin layer 16 or the second resin layer 20 is resistant to silanization in the organic solvent.

Further, while not shown in FIG. 4A through FIG. 4C, in some other examples, prior to selectively attaching the first primer set 30 in the depression 22 and the second primer set 32 over the pillar 24 but after silanizing one of the first resin layer 16 or the second resin layer 20, the method further comprises selectively attaching a first polymeric hydrogel to the silanized surface of the one of: (i) the first resin layer 16 within the depression 22, or (ii) the second resin layer 20 that forms the pillar 24; and selectively attaching a second polymeric hydrogel to the other of: (i) the first resin layer 16 within the depression 22, or (ii) the second resin layer 20 that forms the pillar 24, which is resistant to silanization. As such, in some examples, two different polymeric hydrogels are respectively applied to the first resin layer 16 within the depression 22 and to the second resin layer 20 that forms the pillar 24. In these examples, the two different polymeric hydrogels may be any of the examples set forth herein as long as they are orthogonal in that they selectively and respectively attach to the desired orthogonally reactive resin layer 16, 20.

It is to be understood that in any of these example methods, the interstitial regions 26 (e.g., formed from exposed portions of the inert layer 18 after the etching processes) are inert to the surface functionalization of the first and second resin layers 16, 20. As such, the interstitial regions 26 are free of the primer sets 30, 32, silanes, and/or polymeric hydrogels.

In some examples, the method shown in FIG. 4A through FIG. 4C may include an additional etching process to remove exposed portions of the inert layer 18. The etchant used should not deleteriously affect the surface chemistry (e.g., the primer sets 30, 32, alone or attached to respective polymeric hydrogels). In an example, exposed portions of the inert layer 18 may be removed using a wet etching process that is selective to the material of the inert layer 18.

While FIG. 4A through FIG. 4C illustrate the formation of a single discrete region 21 including the depression 22 and the pillar 24, it is to be understood that a plurality of discrete regions 21 (each including a depression 22 and a pillar 24) may be formed, e.g., where each discrete region 21 is isolated from each other discrete region 21 by interstitial regions 26 (as described in reference to FIG. 1B).

Accordingly, the method depicted in FIG. 4A through FIG. 4C is suitable for forming a patterned substrate, comprising: a multi-layer structure 12 including a first resin layer 16 positioned over a base support 14, the first resin layer 16 comprising a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; a second resin layer 20 positioned over the first resin layer 16, the second resin layer 20 comprising a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, wherein the second functional group is orthogonal to the first functional group; and an inert layer 18 positioned between the first resin layer 16 and the second resin layer 20, wherein the inert layer 18 is inert to the first and second functional groups; a plurality of discrete regions 21 defined in the multi-layer structure 12 and separated by exposed portions of the inert layer 18, each of the plurality of discrete regions 21 including: a depression 22 defined through the inert layer 18 and in the first resin layer 16; and a pillar 24 defined in the second resin layer 20 and positioned adjacent to the depression 22. Further, in some examples, a first primer set 30 is attached in each depression 22 via the first functional group of the first resin layer 16, and a second primer set 32 is attached to each pillar 24 via the second functional group of the second resin layer 20. Still further, in some examples, a first polymeric hydrogel is attached in each depression 22 via the first functional group of the first resin layer 16; a first primer set 30 is attached to the first polymeric hydrogel; a second polymeric hydrogel is attached to each pillar 24 via the second functional group of the second resin layer 20; and a second primer set 32 is attached to the second polymeric hydrogel.

### Method of Forming a Flow Cell Including Multi-Depth Depressions

An example of a method of forming a flow cell including a multi-depth depression 22′ is depicted in FIG. 6A through FIG. 6C. This example method involves contacting a multi-layer stack (not shown prior to being patterned) including a base support 14, a first resin layer 16′ over the base support 14, a second resin layer 20′ over the first resin layer 16′, and a third resin layer 19 over the second resin layer 20′ with a working stamp 130′ to define a discrete multi-depth feature 176 in the third resin layer 19, wherein: the multi-depth feature 176 includes a deep portion 172 and a shallow portion 174 directly adjacent to the deep portion 172; the first resin layer 16′ of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and the second resin layer 20′ of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and etching the multi-layer stack having the discrete multi-depth feature 176 defined therein i) at the deep portion 172 to form a first portion of a multi-depth depression 22′ extending through the second resin layer 20′ and having a bottom defined by a surface S₁ of the first resin layer 16′, and ii) at each of the shallow portions 174 to form a second portion of the multi-depth depression 22′ and expose a surface S₂ of the second resin layer 20′.

The multi-layer stack may be formed using any of the deposition and curing methods described herein in regard to the resin layers 16, 20 of the multi-layer stack 48 (e.g., depicted in FIG. 3A through FIG. 3C). In this example, the first resin layer 16′ will be deposited and cured over the base support 14, and the second resin layer 20′ will be deposited and cured over the first resin layer 16′. It is to be understood, however, that the third resin layer 19 may be deposited and left uncured at the outset of the method (to facilitate patterning of the third resin layer 19). It is to be further understood that in this example, the functional group(s) of the polymer of the first resin layer 16′ are orthogonal to the functional group(s) of the polymer of the second resin layer 20′. As such, in one example, one of the first resin layer 16′ or the second resin layer 20′ may be the organic epoxy resin composition described herein, and the other of the first resin layer 16′ or the second resin layer 20′ may be the epoxy siloxane resin composition described herein. As another example, one of the first resin layer 16′ or the second resin layer 20′ may be the thiol-ene resin composition described herein (or another thiol-based resin), and the other of the first resin layer 16′ or the second resin layer 20′ may be a non-thiolated resin composition.

In this example method, a working stamp 130′ is pressed into the third resin layer 19 (e.g., while the third resin layer 19 is soft). This creates an imprint of the working stamp 130′ features in the third resin layer 19. After the working stamp 130′ is pressed into the third resin layer 19, the third resin layer 19 may be cured while the working stamp 130′ is in place. Curing may be accomplished by exposure to actinic radiation or heat, and will depend upon the chemistry of the third resin layer 19.

Any of the materials for the working stamp 130 may also be used for the working stamp 130′. It is to be understood that the working stamp 130′ differs from the working stamp 130 in that the working stamp 130′ includes two adjacent protrusions, where each protrusion has a different height with respect to one another (as shown in FIG. 6A). In other words, the working stamp 130′ includes a negative replica of the multi-depth feature 176. As such, the working stamp 130′ is suitable for defining a discrete multi-depth feature 176 in the third resin layer 19 (of the multi-layer stack) that can be etched to form one or more multi-depth depression(s) 22′.

As shown in FIG. 6A, after curing, the working stamp 130′ is released. This creates the multi-depth feature 176 including a deep portion 172 and a shallow portion 174 directly adjacent to the deep portion 172 in the third resin layer 19. While FIG. 6A depicts the formation of a single multi-depth feature 176 including the deep portion 172 and the shallow portion 174 in the multi-layer stack, it is to be understood that a plurality of multi-depth features 176 (each including a deep portion 172 and a shallow portion 174) may be formed in the third resin layer 19.

As shown in FIG. 6B, the example method proceeds by etching the multi-layer stack at the deep portion 172 to form a first (e.g., deep) portion of the multi-depth depression 22′ extending through the second resin layer 20′ and having a bottom defined by a surface S₁ of the first resin layer 16′. The method further includes etching the multi-layer stack at the shallow portion 174 to expose a surface S₂ of the second resin layer 20′ and form a second (e.g., shallow) portion of the multi-depth depression 22′. In this example, any remaining amount of the third resin layer 19 may form at least a portion of the wall(s) of the multi-depth depression 22′.

To etch the multi-layer stack, a series of etching processes is performed. At the outset, an etchant is selected to partially etch the third resin layer 19. The third resin layer 19 is orthogonally etchable relative to each of the first and second resin layers 16′, 20′. As such, these layers 16′, 20′ can function as etch stops at desirable times during the etching processes. The third resin layer 19 may be etched using any of the examples set forth herein for the second resin layer 20 described in reference to FIG. 4B, as long as it does not also etch the first and second resin layers 16′, 20′.

During this etching process, the exposed surface of the third resin layer 19 is etched away until the second resin layer 20′ is exposed at the deep portion 172. The second resin layer 20′ acts as an etch stop during this etching process, and thus once the second resin layer 20′ is exposed at deep portion 172, etching is stopped. This etching process decreases the height of the third resin layer 19 at the shallow portion 174 and at those areas surrounding the multi-depth feature 176. The decrease in height is equivalent to the thickness of the portion of the third resin layer 19 that is present in the deep portion 172 prior to etching.

Once the second resin layer 20′ is exposed at deep portion 172, the exposed portion of the second resin layer 20′ may then be removed via an etching process that is selective to the second resin layer 20′ (i.e., the remaining third resin layer 19 will not be affected). During this etching process, the exposed surface of the second resin layer 20′ is etched away until the first resin layer 16′ is exposed at the deep portion 172. The first resin layer 16′ acts as an etch stop during this etching process, and thus once the first resin layer 16′ is exposed at deep portion 172, etching is stopped.

The first resin layer 16′ exposed at deep portion 172 forms the bottom surface S₁ of the multi-depth depression 22′. Because the third resin layer 19 remains over the second resin layer 20′ after the series of etching processes at the deep portion 172, this layer 19 is exposed to additional etching to create the shallow portion of the multi-depth depression 22′. To form the shallow portion, the third resin layer 19 is again etched until the surface S₂ of the second resin layer 20′ is exposed at the shallow portion 174 of the multi-depth feature 176. Because the first and second resin layers 16′, 20′ are orthogonally etchable with respect to the third resin layer 19, the first resin layer 16′ exposed at deep portion 172 will not be affected during this etching process, and the second resin layer 20′ will act as an etch stop once it is exposed at the shallow portion 174. Additionally, because the third resin layer 19 is thicker at regions surrounding the multi-depth feature 176, portions of the layer 19 remain after the multi-depth depression 22′ is formed (as shown in FIG. 6B). The top surface of these portions becomes the interstitial regions 26.

The etching processes form the patterned substrate, which in this example is the multi-layer structure 12′.

In other instances, the orthogonally reactive resin layers 20′, 16′ are susceptible to the same etchant. For example, two orthogonal reactive siloxane resins may be etched with the same etchant. As an example, when the second resin layer 20′ and the first resin layer 16′ are orthogonally reactive siloxanes, both of the layers 20′, 16′ may be etched using CF₄ plasma or a mixture of 90% CF₄ and 10% O₂ plasma. In these instances, the layers 20′, 16′ may be etched using a timed process. Timed etching takes into account the etch rate and the thickness of the resin layers 20′, 16′. The timed etching may be performed to remove the resin layer 20′ underlying the deep portion 172, and to remove a desired amount (but not all) of the resin layer 16′ underlying the deep portion 172.

As shown in FIG. 6C, after the multi-layer stack has been patterned and etched to form the multi-depth depression(s) 22′, the method further comprises attaching a first primer set 30 in the first portion of each multi-depth depression 22′; and attaching a second primer set 32 in the second portion of each multi-depth depression 22′. During this process, the primers 34, 36 or 34′, 36′ (not specifically labelled in FIG. 6C) of the primer set 30 may be grafted to the surface S₁ of the first resin layer 16′ (e.g., within the deep portion of the multi-depth depression 22′) or to a first polymeric hydrogel within the deep portion of the multi-depth depression 22′. Further during this process, the primers 38, 40 or 38′, 40′ (not specifically labelled in FIG. 6C) of the primer set 32 may be grafted to the surface S₂ of the second resin layer 20′ (e.g., within the shallow portion of the multi-depth depression 22′) or to a second polymeric hydrogel within the shallow portion of the multi-depth depression 22′. Alternatively, the primers 34, 36 or 34′ 36′ of the primer set 30 may be grafted to the surface S₂ of the second resin layer 20′ or to a second polymeric hydrogel, and the primers 38, 40 or 38′, 40′ of the primer set 32 may be grafted to the surface S₁ of the first resin layer 16′ or to a first polymeric hydrogel. While not shown in FIG. 6C, the primers 34, 36 or 34′, 36′, or 38, 40, or 38′, 40′ that attach to the second resin layer 20′ may be attached to any exposed portions of the second resin layer 20′ (e.g., those surfaces that form the sidewalls of the deep portion of the multi-depth depression 22′).

Any of the grafting techniques described herein may be used to attach the primer sets 30, 32 to the first or second resin layers 16′, 20′ or the polymeric hydrogels. With any of the grafting methods and in some examples, one of primer set 30 or 32 reacts with reactive groups of the first resin layer 16′, while having no affinity for the functional groups of the second resin layer 20′ or the interstitial regions 26. Further, in these examples, the other of the primer set 32 or 30 reacts with reactive groups of the second resin layer 20′, while having no affinity for the functional groups of first resin layer 16′ or the interstitial regions 26. As such, one primer set 30 or 32 may be grafted within the deep portion of the multi-depth depression 22′, and the other primer set 32 or 30 may be grafted within the shallow portion of the multi-depth depression 22′.

While not shown in FIG. 6A through FIG. 6C, in some examples, prior to selectively attaching the first primer set 30 and selectively attaching the second primer set 32, the method further comprises exposing the multi-layer stack to a silane in an organic solvent, thereby selectively silanizing a surface S₁ or S₂ of one of the first resin layer 16′ or the second resin layer 20′. As examples, the silane is selected from the group consisting of norbornene silane and trimethoxysilane and the organic solvent is selected from the group consisting of acetonitrile and dimethyl sulfoxide. In one specific example, the silane may be norbornene silane and the organic solvent may be acetonitrile. The first and second functional groups of the first and second resin layers 16′, 20′ may be controlled so that the first and second resin layers 16′, 20′ are selectively silanized or activated. As described, the first and second functional groups of the first and second resin layers 16′, 20′ may be orthogonal (with respect to one another). As such, one of the first resin layer 16′ or the second resin layer 20′ is resistant to silanization in the organic solvent.

Further, while not shown in FIG. 6A through FIG. 6C, prior to selectively attaching the first primer set 30 and selectively attaching the second primer set 32 (but after silanizing the first resin layer 16′ or the second resin layer 20′), the method may further comprise selectively attaching a first polymeric hydrogel to the silanized surface S₁ or S₂ of the one of: (i) the first resin layer 16′, or (ii) the second resin layer 20′; and selectively attaching a second polymeric hydrogel to the other of: (i) the first resin layer 16′, or (ii) the second resin layer 20′, which is resistant to silanization. In this example, the silanized first resin layer 16′ attaches one of the primer sets 30 or 32 through the first or second polymeric hydrogel, while the second resin layer 20′ attaches the other primer set 32 or 30 through the other of the hydrogels.

When the polymeric hydrogels are used, the first polymeric hydrogel may be applied and selectively attached to the first resin layer 16′ using any suitable deposition technique. The attachment between the first polymeric hydrogel and the first resin layer 16′ is selective due to the functional groups being selected to attach to one another. Because the first polymeric hydrogel does not attach to the layer 19 or the second resin layer 20′, the first polymeric hydrogel may be easily removed (e.g., via sonication, washing, wiping, etc.) from the layer 19 and the second resin layer 20′. The second polymeric hydrogel may be selectively applied to the second resin layer 20′ using any suitable deposition technique under high ionic strength conditions (e.g., in the presence of 10×PBS, NaCl, KCl, etc.). Not only are the functional groups (of the second polymeric hydrogel and the layer 20′) selected to attach to one another, but the high ionic strength conditions keep the second polymeric hydrogel from depositing on or adhering to the first polymeric hydrogel.

As described, any remaining amount of the third resin layer 19 that is not removed during the etching process may form interstitial regions 26. The interstitial regions 26 separate one multi-depth depression 22′ from each other multi-depth depression 22′, when an array of multi-depth depressions 22′ is included in the flow cell. In some examples, the third resin layer 19 is inert to the grafting chemistries of the primer sets 30, 32 and the first and second resin layers 16′, 20′. As such, the interstitial regions 26 are free of the primer sets 30, 32, of silane, and/or of polymeric hydrogels.

While FIG. 6A through FIG. 6C illustrate the formation of a single multi-depth depression 22′ including a shallow portion and a deep portion (where each portion has a primer set 30 or 32 grafted therein), it is to be understood that a plurality of multi-depth depressions 22′ may be formed, where each multi-depth depression 22′ is isolated from each other multi-depth depression 22′ by interstitial regions 26 (as described in reference to FIG. 1C).

As such, the method depicted in FIG. 6A through FIG. 6C is suitable for forming a patterned substrate comprising: a multi-layer stack including: a first resin layer 16′ positioned over a base support 14; a second resin layer 20′ positioned over the first resin layer 16′; one of the first resin layer 16′ or the second resin layer 20′ comprising an epoxy siloxane and an other of the second resin layer 20′ or the first resin layer 16′ comprising a carbon-containing functional group; and a third resin layer 19 positioned over the second resin layer 20′; and a plurality of multi-depth depressions 22′ defined in the multi-layer stack and separated by exposed portions of the third resin layer 19, each of the plurality of multi-depth depressions 22′ including: a depression defined through the second resin layer 20′ and having a bottom defined by a surface S₁ of the first resin layer 16′; and an exposed surface S₂ of the second resin layer 20′ positioned adjacent to the depression. In one example of this patterned substrate, a first primer set 30 is attached to the bottom defined by the surface S₁ of the first resin layer 16′; and a second primer set 32 is attached to the exposed surface S₂ of the second resin layer 20′. In another example of this patterned substrate, the first polymeric hydrogel is attached to the bottom defined by the surface S₁ of the first resin layer 16′; a first primer set 30 is attached to the first polymeric hydrogel; a second polymeric hydrogel is attached to the exposed surface S₂ of the second resin layer 20′; and a second primer set 32 is attached to the second polymeric hydrogel.

### Method of Forming a Flow Cell Including Multi-Height Protrusions

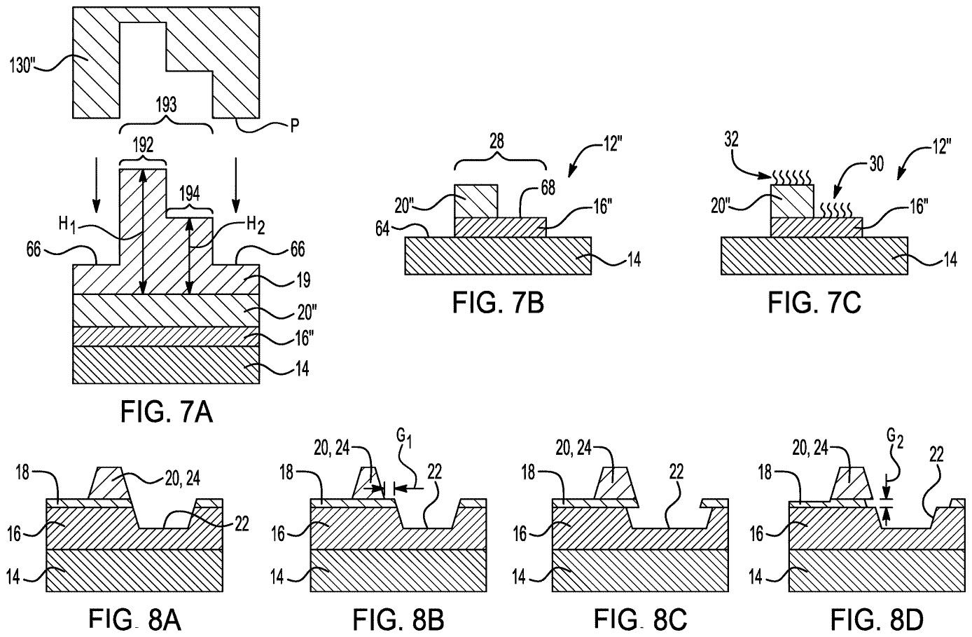

An example of a method of forming a flow cell 10 including a multi-height protrusion 28 is depicted in FIG. 7A through FIG. 7C. This example method involves imprinting a third resin layer 19 of a multi-layer stack (not shown unpatterned) to form a multi-height convex region 193 including a first region 192 with a first height H₁ and a second region 194 with a second height H₂ that is smaller than the first height H₁, wherein the multi-layer stack includes the third resin layer 19 over a second resin layer 20″ over a first resin layer 16″ over a base support 14, wherein: the first resin layer 16″ of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and the second resin layer 20″ of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and selectively etching the multi-layer stack i) at the first and second regions 192, 194 to form a multi-height protrusion 28 including an exposed portion of the second resin layer 20″ and an exposed portion of the first resin layer 16″, and ii) around the multi-height convex region 193 to expose the base support 14.

The multi-layer stack may be formed using any of the deposition and curing methods described herein in regard to the resin layers 16, 20 of the multi-layer stack 48 (e.g., depicted in FIG. 3A through FIG. 3C). In this example, the first resin layer 16″ will be deposited and cured over the base support 14, and the second resin layer 20″ will be deposited and cured over the first resin layer 16″. It is to be understood, however, that the third resin layer 19 may be deposited and left uncured at the outset of the method (to facilitate patterning of the third resin layer 19). It is to be further understood that in this example, the functional group(s) of the polymer of the first resin layer 16″ are orthogonal to the functional group(s) of the polymer of the second resin layer 20″. As such, in one example, one of the first resin layer 16″ or the second resin layer 20″ may be the organic epoxy resin composition described herein, and the other of the first resin layer 16″ or the second resin layer 20″ may be the siloxane-based resin composition described herein. As another example, one of the first resin layer 16″ or the second resin layer 20″ may be the thiol-ene resin composition described herein (or another thiol-based resin), and the other of the first resin layer 16″ or the second resin layer 20″ may be a non-thiolated resin composition.

In this example method, a working stamp 130″ is pressed into the third resin layer 19 (e.g., while the third resin layer 19 is soft). This creates an imprint of the working stamp 130″ features in the third resin layer 19. After the working stamp 130″ is pressed into the third resin layer 19, the third resin layer 19 may be cured while the working stamp 130″ is in place. Curing may be accomplished by exposure to actinic radiation or heat, and will depend upon the chemistry of the third resin layer 19.

Any of the materials for the working stamp 130′ (depicted in FIG. 6A) may also be used for the working stamp 130″. It is to be understood that the working stamp 130″ differs from the working stamp 130′ and from the working stamp 130 in that the working stamp 130″ includes two adjacent concave regions, where each concave region has a different depth/volume with respect to a planar surface P of the stamp 130″ (as shown in FIG. 7A). The depth/volume of each of the concave regions may correspond to the desired size of each portion of the multi-height convex region 193. In other words, the working stamp 130″ includes a negative replica of the multi-height convex region 193. As such, the working stamp 130″ is suitable for defining features in the resin layer 19 that can be etched to form one or more multi-height protrusion(s) 28.

As shown in FIG. 7A, after curing, the working stamp 130″ is released. This creates a multi-height convex region 193 including a first region 192 having a first height H₁ and a second region 194 having a second height H₂ in the third resin layer 19, where the second height H₂ is smaller than the first height H₁. While FIG. 7A depicts the formation of a single multi-height convex region 193 including a first region 192 and a second region 194 in the multi-layer stack, it is to be understood that a plurality of multi-height convex regions 193 (each including a first region 192 having a first height H₁ and a second region 194 having a second height H₂) may be formed in the third resin layer 19.

The example method proceeds by etching the multi-layer stack. To etch the multi-layer stack, a series of etching processes is performed. The third resin layer 19 is orthogonally etchable relative to the second resin layer 20″. As such, this layer 20″ can function as an etch stop at a desirable time during the etching processes.

In this example, the multi-layer stack is selectively etched around the multi-height convex region 193 to expose a portion of the base support 14. In this example, etching exposes the portions 64 of the base support 14, and the portions of the multi-layer stack that underlie the multi-height convex region 193 remain unetched. This effectively extends the multi-height convex region 193 down to the base support 14.

In this example, the third resin layer 19 is etched, followed by a portion of the second resin layer 20″, and a portion of the first resin layer 16″. Any exposed areas of the layers 19, 20″, 16″ around the multi-height convex region 193 are etched during these etching process, as indicated by the downward arrows in FIG. 7A.

During the first etching process in this series, the exposed surface of the third resin layer 19 is etched away until the second resin layer 20″ is exposed at the portions 66 (i.e., the portions of second resin layer 20″ underlying the portions 66). The second resin layer 20″ acts as an etch stop during this etching process, and thus once the second resin layer 20″ underlying the portions 66 is exposed, etching is stopped. As an example, when the third resin layer 19 is the organic epoxy resin described herein, the layer 19 may be etched using 100% O₂. Because the entire third resin layer 19 is exposed to etching, the first and second heights H₁ and H₂ are reduced. However, because the portions 66 of the third resin layer 19 around the multi-height convex region 193 are thinner than each of the first and second heights H₁ and H₂, the second resin layer 20″ underlying these portions 66 will be exposed, and etching will be stopped, before the multi-height convex region 193 is etched away. The decrease in height is equivalent to the thickness of the portion of the third resin layer 19 that make up the portions 66 prior to etching.

Once the second resin layer 20″ is exposed around the multi-height convex region 193, the exposed portion of the second resin layer 20″ may then be removed via an etching process that is selective to the second resin layer 20″ (i.e., the remaining third resin layer 19 will not be affected). During this etching process, the exposed surface of the second resin layer 20″ is etched away until the first resin layer 16″ around the multi-height convex region 193 is exposed.

Once the first resin layer 16″ is exposed around the multi-height convex region 193, the exposed portion of the first resin layer 16″ may then be removed via an etching process that is selective to the first resin layer 16″ (i.e., the remaining third resin layer 19 will not be affected). During this etching process, the exposed surface of the first resin layer 16″ is etched away until the portions 64 of the base support 14 are exposed. The base support 14 acts as an etch stop during this etching process, and thus once the base support 14 is exposed, etching is stopped.

In some instances, the orthogonally reactive resin layers 20″, 16″ are susceptible to the same etchant. For example, two orthogonally reactive siloxane resins may be etched with the same etchant. As an example, when the second resin layer 20″ and the first resin layer 16″ are orthogonally reactive siloxanes, both of the layers 20″, 16″ may be etched using CF₄ plasma or a mixture of 90% CF₄ and 10% O₂ plasma. In these instances, the layers 20″, 16″ may be etched until the base support 14 (at areas underlying the portions 66) is exposed. The base support 14 acts as an etch stop during this etching process, and thus once the base support 14 is exposed, etching is stopped.

In other instances, the resin layers 20″, 16″ are orthogonally reactive and orthogonally etchable (i.e., the etchant for one layer 20″ does not affect the other layer 16″). In these other instances, two different etchants are used. The first resin layer 16″ acts as an etch stop for the etching process of the second resin layer 20″, and thus once the first resin layer 16″ is exposed, etching of the second resin layer 20″ is stopped. Similarly, the base support 14 acts as an etch stop for the etching process of the first resin layer 16″, and thus once the base support 14 is exposed, etching of the first resin layer 16″ is stopped. In this example, the etchants used will depend upon the resin layers 20″, 16″ used.

After the base support 14 (underlying the portions 66) is exposed, the multi-height convex region 193 is then selectively etched to remove a portion of the third resin layer 19 that corresponds with the region 194 of the multi-height convex region 193, and a portion of the second resin layer 20″ underlying the region 194, thereby exposing a surface 68 of first resin layer 16″ (shown in FIG. 7B). Different etching techniques may be used for the region 194 of the third resin layer 19 and the portion of the second resin layer 20″ underlying the region 194. As an example, when the third resin layer 19 is the organic epoxy resin described herein, the layer 19 may be etched using 100% O₂ plasma. Due to the height differences of the third resin layer 19, a portion of the region 192 of the third resin layer 19 remains (although the height is further reduced). It is to be understood that the portion of the second resin layer 20″ underlying the first height H₁ (underlying region 192) remains at least substantially intact after etching of the region 194 is complete.

Once the region 194 is removed, the portion of the second resin layer 20″ underlying the region 194 is also removed to expose the surface 68 of the first resin layer 16″. When the resin layers 20″, 16″ are susceptible to the same etchants, a timed etching process is used to remove the portion of the resin layer 20″, which takes into account the etch rate and the thickness of the resin layer 20″. The timed etching process is performed until the surface 68 of the resin layer 16″ (i.e., the portion underlying the region 194) is exposed. When the resin layers 20″, 16″ are susceptible to different etchants, a suitable etchant may be used to remove the portion of the resin layer 20″, and the surface 68 of the resin layer 16″ will act as an etch stop. Because the portion of the region 192 of the third resin layer 19 remains intact during the exposure of the surface 68, the portion of the second resin layer 20″ underlying the region 192 also remains at least substantially intact after etching is complete.

The remaining portion of the layer 19 (e.g., the portion of the region 192 of the multi-height convex region 193) is then removed, thereby exposing a surface of the second resin layer 20″ underlying the portion 192 (as shown in FIG. 7B). The remaining portion of the layer 19 may be removed with an etching technique that will not deleteriously affect the multi-height protrusion 28 or the exposed surfaces 64 of the base support 14, or in an organic solvent that will not deleteriously affect the multi-height protrusion 28 or the exposed surfaces 64 of the base support 14. Depending upon the materials, a suitable etchant may be 100% O₂ plasma, or suitable organic solvents may be acetone, PGMEA, or DMSO.

The processes described in reference to FIG. 7A through FIG. 7B form the multi-height protrusion 28, as shown in FIG. 7B. This is an example of the patterned substrate depicted in FIG. 1D, which in this example, is the multi-layer structure 12″.

Following the patterning and etching of the multi-layer stack, the method may further include attaching a first primer set 30 over the exposed portion of the first resin layer 16″, and attaching a second primer set 32 over the exposed portion of the second resin layer 20″, as shown in FIG. 7C.

Any of the grafting techniques described herein may be used to attach the primer sets 30, 32 to the desired resin layer 16″ or 20″ or to the desired polymeric hydrogel overlying the desired resin layer 16″ or 20″. During this process, the primers 34, 36 or 34′, 36′ (not specifically labeled in FIG. 7C) of the primer set 30 may be grafted to the resin layer 16″ of the multi-height protrusion 28 or a polymeric hydrogel attached to the resin layer 16″. Further during this process, the primers 38, 40 or 38′, 40′ (not specifically labeled in FIG. 7C) of the primer set 32 may be grafted to the second resin layer 20″ of the multi-height protrusion 28 or a polymeric hydrogel attached to the resin layer 20″. Alternatively, the primers 34, 36 or 34′ 36′ may be grafted to the second resin layer 20″ (or hydrogel thereon), and the primers 38, 40 or 38′, 40′ may be grafted to the first resin layer 16″ (or hydrogel thereon).

While not shown in FIG. 7A through FIG. 7C, in some examples, prior to selectively attaching the first primer set 30 over the exposed portion of the first resin layer 16″ and selectively attaching the second primer set 32 over the exposed portion of the second resin layer 20″, the method further comprises exposing the multi-layer stack to a silane in an organic solvent, thereby selectively silanizing a surface of one of: (i) the exposed portion of the first resin layer 16″, or (ii) the exposed portion of the second resin layer 20″. In one suitable example, the silane is selected from the group consisting of norbornene silane and trimethoxysilane and the organic solvent is selected from the group consisting of acetonitrile and dimethyl sulfoxide. One specific example is norbornene silane in acetonitrile.

The first and second functional groups of the first and second resin layers 16″, 20″ may be controlled so that the first and second resin layers 16″, 20″ are selectively silanized or activated. The first and second functional groups of the first and second resin layers 16″, 20″ may be orthogonal (with respect to one another). As such, one of the first resin layer 16″ or the second resin layer 20″ is resistant to silanization in the organic solvent. In one example, the silanized first resin layer 16″ or second resin layer 20″ attaches one of the primer sets 30, 32, and the other of the first resin layer 16″ or the second resin layer 20″ attaches the other of the primer sets 32, 30.

While not shown in FIG. 7A through FIG. 7C, in some examples, prior to selectively attaching the first primer set 30 over the exposed portion of the first resin layer 16″ and the second primer set 32 over the exposed portion of the second resin layer 20″ (but after silanizing the first or the second resin layer 16″ or 20″), the method further comprises selectively attaching a first polymeric hydrogel to the silanized surface of the one of: (i) the exposed portion of the first resin layer 16″, or (ii) the exposed portion of the second resin layer 20″; and selectively attaching a second polymeric hydrogel to the other of: (i) the exposed portion of the first resin layer 16″, or (ii) the exposed portion of the second resin layer 20″, which is resistant to silanization. The first and second polymeric hydrogels may be applied and selectively attached or selectively applied and attached as described herein in reference to the other methods.

It is to be understood that in this example method, the exposed base support 14 may form interstitial regions 26. The interstitial regions 26 may separate one multi-height protrusion 28 from each other multi-height protrusion 28, when an array of multi-height protrusions 28 is included in the patterned substrate. It is to be understood that in this example, the interstitial regions 26 are free of the primer sets 30, 32. The interstitial regions 26 may further be free of silane and/or polymeric hydrogels.

While FIG. 7A through FIG. 7C illustrate the formation of a single multi-height protrusion 28 (where each layer 16″ and 20″ has a primer set 30 or 32 respectively grafted thereto), it is to be understood that an array of multi-height protrusions 28 may be formed, where each multi-height protrusion 28 is isolated from each other multi-height protrusion 28 by interstitial regions 26 (similar to the example depicted in FIG. 1D).

As such, the method depicted in FIG. 7A through FIG. 7C is suitable for forming a patterned substrate comprising: a base support 14; and a plurality of multi-height protrusions 28 defined over the base support 14 and separated by exposed portions 64 of the base support 14, each of the multi-height protrusions 28 including: a first resin layer 16″ having an exposed surface 68, the first resin layer 16″ comprising a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and a resin layer 20″ over a portion of the first resin layer 16″ adjacent to the exposed surface 68, the resin layer 20″ comprising a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group being orthogonal to the first functional group. In one example of the patterned substrate, a first primer set 30 is attached to the exposed surface 68 of the first resin layer 16″; and a second primer set 32 is attached to the second resin layer 20″. In another example of the patterned substrate, a first polymeric hydrogel is attached to the exposed surface 68 of the first resin layer 16″; a first primer set 30 is attached to the first polymeric hydrogel; a second polymeric hydrogel attached to the second resin layer 20″; and a second primer set 32 attached to the second polymeric hydrogel.

### CLAUSES

Clause 1. A method, comprising:
contacting a multi-layer stack including a base support, a first resin layer over the base support, an inert layer over the first resin layer, and a second resin layer over the inert layer with a working stamp to define a plurality of initial discrete regions in the second resin layer of the multi-layer stack,
wherein:
each of the initial discrete regions includes a concave region and a convex region that are directly adjacent to each other;
the first resin layer of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane;
the second resin layer of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and
the inert layer of the multi-layer stack comprises a polymer that is inert to the first and second functional groups;
etching the multi-layer stack having the plurality of initial discrete regions defined therein i) at each of the concave regions to form a depression through the inert layer and in the first resin layer, ii) at each convex regions to form a pillar in the second resin layer, and iii) to expose a surface of the inert layer around each of a plurality of final discrete regions;
selectively attaching a first primer set in each depression; and
selectively attaching a second primer set over each pillar.
Clause 2. The method as defined in clause 1, wherein prior to selectively attaching the first primer set in each depression and the second primer set over each pillar, the method further comprises exposing the multi-layer stack to a silane in an organic solvent, thereby selectively silanizing a surface of one of: (i) the first resin layer within the depression, or (ii) the second resin layer that forms the pillar.
Clause 3. The method as defined in clause 2, wherein another of the first resin layer or the second resin layer is resistant to silanization in the organic solvent.
Clause 4. The method as defined in clause 3, wherein prior to selectively attaching the first primer set in each depression and the second primer set over each pillar, the method further comprises:
selectively attaching a first polymeric hydrogel to the silanized surface of the one of: (i) the first resin layer within the depression, or (ii) the second resin layer that forms the pillar; and
selectively attaching a second polymeric hydrogel to the other of: (i) the first resin layer within the depression, or (ii) the second resin layer that forms the pillar, which is resistant to silanization.
Clause 5. The method as defined in any of clause 2 through clause 4, wherein the silane is selected from the group consisting of norbornene silane and trimethoxysilane and the organic solvent is selected from the group consisting of acetonitrile and dimethyl sulfoxide.
Clause 6. The method as defined in clause 1, wherein one of the first resin layer or the second resin layer is an organic epoxy resin composition, and an other of the first resin layer or the second resin layer is a siloxane-based resin composition.
Clause 7. The method as defined in clause 6, wherein the siloxane-based resin composition is formed from an epoxy siloxane resin composition including a monomer or cross-linkable copolymer selected from the group consisting of an epoxy functionalized silsesquioxane; tetrakis(epoxycyclohexyl ethyl)tetramethyl cyclotetrasiloxane; a copolymer of (epoxycyclohexylethyl)methylsiloxane and dimethylsiloxane; 1,3-bis[2-(3,4-epoxycyclohexyl)ethyl] tetramethyl disiloxane; 1,3-bis(glycidoxypropyl)tetramethyl disiloxane; and combinations thereof.
Clause 8. The method as defined in clause 1, wherein one of the first resin layer or the second resin layer is a thiol-ene resin composition, and an other of the first resin layer or the second resin layer is a non-thiolated resin composition.
Clause 9. A patterned substrate, comprising:
a multi-layer structure including:
a first resin layer positioned over a base support, the first resin layer comprising a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane;
a second resin layer positioned over the first resin layer, the second resin layer comprising a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, wherein the second functional group is orthogonal to the first functional group; and
an inert layer positioned between the first resin layer and the second resin layer, wherein the inert layer is inert to the first and second functional groups;
a plurality of discrete regions defined in the multi-layer structure and separated by exposed portions of the inert layer, each of the plurality of discrete regions including:
a depression defined through the inert layer and in the first resin layer; and
a pillar defined in the second resin layer and positioned adjacent to the depression.
Clause 10. The patterned substrate as defined in clause 9, further comprising:
a first primer set attached in each depression via the first functional group of the first resin layer; and
a second primer set attached to each pillar via the second functional group of the second resin layer.
Clause 11. The patterned substrate as defined in clause 9, further comprising:
a first polymeric hydrogel attached in each depression via the first functional group of the first resin layer;
a first primer set attached to the first polymeric hydrogel;
a second polymeric hydrogel attached to each pillar via the second functional group of the second resin layer; and
a second primer set attached to the second polymeric hydrogel.
Clause 12. A method, comprising:
contacting a multi-layer stack including a base support, a first resin layer over the base support, a second resin layer over the first resin layer, and a third resin layer over the second resin layer with a working stamp to define a plurality of discrete multi-depth features in the third resin layer, wherein:
each of the multi-depth features includes a deep portion and a shallow portion directly adjacent to the deep portion;
the first resin layer of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and
the second resin layer of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and
etching the multi-layer stack having the plurality of discrete multi-depth features defined therein i) at each of the deep portions to form a first portion of a multi-depth depression extending through the second resin layer and having a bottom defined by a surface of the first resin layer, and ii) at each of the shallow portions to form a second portion of the multi-depth depression and to expose a surface of the second resin layer.
Clause 13. The method as defined in clause 12, further comprising:
attaching a first primer set in the first portion of each multi-depth depression; and
attaching a second primer set in the second portion of each multi-depth depression.
Clause 14. The method as defined in clause 13, wherein prior to selectively attaching the first primer set and selectively attaching the second primer set, the method further comprises exposing the multi-layer stack to a silane in an organic solvent, thereby selectively silanizing a surface of one of: (i) the first resin layer or (ii) the second resin layer.
Clause 15. The method as defined in clause 14, wherein an other of the first resin layer or the second resin layer is resistant to silanization in the organic solvent.
Clause 16. The method as defined in clause 15, wherein prior to selectively attaching the first primer set and selectively attaching the second primer set, the method further comprises:
selectively attaching a first polymeric hydrogel to the silanized surface of the one of: (i) the first resin layer, or (ii) the second resin layer; and
selectively attaching a second polymeric hydrogel to the other of: (i) the first resin layer, or (ii) the second resin layer, which is resistant to silanization.
Clause 17. The method as defined in any one of clause 14 through clause 16, wherein the silane is selected from the group consisting of norbornene silane and trimethoxysilane and the organic solvent is selected from the group consisting of acetonitrile and dimethyl sulfoxide.
Clause 18. The method as defined in clause 12, wherein one of the first resin layer or the second resin layer is an organic epoxy resin composition, and an other of the first resin layer or the second resin layer is a siloxane-based resin composition.
Clause 19. The method as defined in clause 12, wherein one of the first resin layer or the second resin layer is a thiol-ene resin composition, and an other of the first resin layer or the second resin layer is a non-thiolated resin composition.
Clause 20. A patterned substrate, comprising:
a multi-layer structure including:
a first resin layer positioned over a base support;
a second resin layer positioned over the first resin layer;
one of the first resin layer or the second resin layer comprising an epoxy siloxane and an other of the second resin layer or the first resin layer comprising a carbon-containing functional group; and
a third resin layer positioned over the second resin layer; and
a plurality of multi-depth depressions defined in the multi-layer structure and separated by exposed portions of the third resin layer, each of the plurality of multi-depth depressions including:
a depression defined through the second resin layer and having a bottom defined by a surface of the first resin layer; and
an exposed surface of the second resin layer positioned adjacent to the depression.
Clause 21. The patterned substrate as defined in clause 20, further comprising:
a first primer set attached to the bottom defined by the surface of the first resin layer; and
a second primer set attached to the exposed surface of the second resin layer.
Clause 22. The patterned substrate as defined in clause 20, further comprising:
a first polymeric hydrogel attached to the bottom defined by the surface of the first resin layer;
a first primer set attached to the first polymeric hydrogel;
a second polymeric hydrogel attached to the exposed surface of the second resin layer; and
a second primer set attached to the second polymeric hydrogel.
Clause 23. A method for patterning a surface of a substrate, comprising:
imprinting a third resin layer of a multi-layer stack to form a multi-height convex region including a first region with a first height and a second region with a second height that is smaller than the first height, wherein the multi-layer stack includes the third resin layer over a second resin layer over a first resin layer over a base support, wherein:
the first resin layer of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and
the second resin layer of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and
selectively etching the multi-layer stack i) at the first and second regions to form a multi-height protrusion including an exposed portion of the second resin layer and an exposed portion of the first resin layer, and ii) around the multi-height convex region to expose the base support.
Clause 24. The method as defined in clause 23, further comprising:
attaching a first primer set over the exposed portion of the first resin layer; and
attaching a second primer set over the exposed portion of the second resin layer.
Clause 25. The method as defined in clause 24, wherein prior to selectively attaching the first primer set over the exposed portion of the first resin layer and attaching the second primer set over the exposed portion of the second resin layer, the method further comprises exposing the multi-layer stack to a silane in an organic solvent, thereby selectively silanizing a surface of one of: (i) the exposed portion of the first resin layer, or (ii) the exposed portion of the second resin layer.
Clause 26. The method as defined in clause 25, wherein an other of the first resin layer or the second resin layer is resistant to silanization in the organic solvent.
Clause 27. The method as defined in clause 26, wherein prior to selectively attaching the first primer set over the exposed portion of the first resin layer and the second primer set over the exposed portion of the second resin layer, the method further comprises:
selectively attaching a first polymeric hydrogel to the silanized surface of the one of: (i) the exposed portion of the first resin layer, or (ii) the exposed portion of the second resin layer; and
selectively attaching a second polymeric hydrogel to the other of: (i) the exposed portion of the first resin layer, or (ii) the exposed portion of the second resin layer, which is resistant to silanization.
Clause 28. The method as defined in any one of clause 25 through clause 27, wherein the silane is selected from the group consisting of norbornene silane and trimethoxysilane and the organic solvent is selected from the group consisting of acetonitrile and dimethyl sulfoxide.
Clause 29. The method as defined in clause 23, wherein one of the first resin layer or the second resin layer is an organic epoxy resin composition, and the other of the first resin layer or the second resin layer is a siloxane-based resin composition.
Clause 30. A patterned substrate, comprising:
a base support; and
a plurality of multi-height protrusions defined over the base support and separated by exposed portions of the base support, each of the multi-height protrusions including:
a first resin layer having an exposed surface, the first resin layer comprising a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and
a second resin layer over a portion of the first resin layer adjacent to the exposed surface, the second resin layer comprising a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group being orthogonal to the first functional group.
Clause 31. The patterned substrate as defined in clause 30, further comprising:
a first primer set attached to the exposed surface of the first resin layer; and
a second primer set attached to the second resin layer.
Clause 32. The patterned substrate as defined in clause 30, further comprising:
a first polymeric hydrogel attached to the exposed surface of the first resin layer;
a first primer set attached to the first polymeric hydrogel;
a second polymeric hydrogel attached to the second resin layer; and
a second primer set attached to the second polymeric hydrogel.
Clause 33. A working stamp, comprising:
a substrate having a planar surface; and
a plurality of discrete features formed in the substrate and separated from one another by the planar surface, each of the discrete features including:
a concave portion defined in the substrate and extending in a first direction from the planar surface; and
a convex portion defined in the substrate and extending in a second direction from the planar surface;
wherein the second direction is opposed to the first direction, and the concave and convex portions are directly adjacent to each other.

### ADDITIONAL NOTES

In any of the methods disclosed herein, it is to be understood that the thicknesses of the various layers, e.g., 16, 20, 18, 19, etc. may be tuned based, at least in part, on the etch selectivity of the layers. Additionally, in the example of FIG. 1B, the thickness of the inert layer 18 may be selected to enable pad hopping of a library template from one primer set 30 to the other primer set 32 in order to achieve amplification across both primer sets (which is desirable for simultaneous paired end sequencing). In one example, thickness of the inert layer 18 (after etching) is 150 nm or less.

Additionally, the pillars 24, depressions 22, multi-depth depressions 22′, and multi-height protrusions 28 are illustrated with vertical sides/sidewalls relative to the surface upon which or in which they are formed. While such geometries can be achieved with dry etching techniques, it is contemplated that the sides/sidewalls may be at other angles depending upon the isotropy of the etching process. As examples, any of the sides/sidewalls may be at an offset angle relative to the surface on which or in which such side/sidewall is formed, where the offset angle ranges from about 45° to about 225°. One example of the slanted sides/sidewalls is shown in FIG. 8A, where each of the pillar 24 and the depression 22 have slanted sides/sidewalls relative to the surface of the inert layer 18.

Still further, the pillar 24 and the depression 22 of the discrete feature 21 are depicted directly adjacent to one another in FIG. 1B (i.e., one side of the pillar 24 aligns with one sidewall of the depression 22). It is to be understood that these components 24, 22 may be separated by a small gap where the underlying layer (e.g., layer 18) is exposed or removed. One example of this gap G1 is shown in FIG. 8B. This gap G1 may result when the second resin 20 is etched at a faster rate than the other layers 18, 16. This gap G1 provides a horizontally oriented space between the pillar 24 and the depression 22. Another example of this gap G2 is shown in FIG. 8D. This gap G2 may result when the inert layer 18 is etched at a faster rate than the other layers 20, 16. This gap G2 provides a vertically oriented space between the pillar 24 and the depression 22, as a portion of the inert layer 18 is removed from beneath the pillar 24 at the edge of the depression 22.

Alternatively, when the etch rate of the resin 16 is faster than the other layers 18, 20, an undercut may be formed in the depression 22, where the depression sidewalls extend slightly beneath the inert layer 18. This example is shown in FIG. 8C.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

While several examples have been described in detail, it is to be understood that the disclosed examples may be modified. Therefore, the foregoing description is to be considered non-limiting.

What is claimed is:

1. A method, comprising:
contacting a multi-layer stack including a base support, a first resin layer over the base support, an inert layer over the first resin layer, and a second resin layer over the inert layer with a working stamp to define a plurality of initial discrete regions in the second resin layer of the multi-layer stack,
wherein:
each of the initial discrete regions includes a concave region and a convex region that are directly adjacent to each other;
the first resin layer of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane;
the second resin layer of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and
the inert layer of the multi-layer stack comprises a polymer that is inert to the first and second functional groups;
etching the multi-layer stack having the plurality of initial discrete regions defined therein i) at each of the concave regions to form a depression through the inert layer and in the first resin layer, ii) at each convex regions to form a pillar in the second resin layer, and iii) to expose a surface of the inert layer around each of a plurality of final discrete regions;
selectively attaching a first primer set in each depression; and
selectively attaching a second primer set over each pillar.

2. The method as defined in claim 1, wherein prior to selectively attaching the first primer set in each depression and the second primer set over each pillar, the method further comprises exposing the multi-layer stack to a silane in an organic solvent, thereby selectively silanizing a surface of one of: (i) the first resin layer within the depression, or (ii) the second resin layer that forms the pillar.

3. The method as defined in claim 2, wherein an other of the first resin layer or the second resin layer is resistant to silanization in the organic solvent.

4. The method as defined in claim 3, wherein prior to selectively attaching the first primer set in each depression and the second primer set over each pillar, the method further comprises:
selectively attaching a first polymeric hydrogel to the silanized surface of the one of: (i) the first resin layer within the depression, or (ii) the second resin layer that forms the pillar; and
selectively attaching a second polymeric hydrogel to the other of: (i) the first resin layer within the depression, or (ii) the second resin layer that forms the pillar, which is resistant to silanization.

5. The method as defined in claim 2, wherein the silane is selected from the group consisting of norbornene silane and trimethoxysilane and the organic solvent is selected from the group consisting of acetonitrile and dimethyl sulfoxide.

6. The method as defined in claim 1, wherein one of the first resin layer or the second resin layer is an organic epoxy resin composition, and an other of the first resin layer or the second resin layer is a siloxane-based resin composition.

7. The method as defined in claim 6, wherein the siloxane-based resin composition is formed from an epoxy siloxane resin composition including a monomer or cross-linkable copolymer selected from the group consisting of an epoxy functionalized silsesquioxane; tetrakis(epoxycyclohexyl ethyl)tetramethyl cyclotetrasiloxane; a copolymer of (epoxycyclohexylethyl)methylsiloxane and dimethylsiloxane; 1,3-bis[2-(3,4-epoxycyclohexyl)ethyl] tetramethyl disiloxane; 1,3-bis(glycidoxypropyl)tetramethyl disiloxane; and combinations thereof.

8. The method as defined in claim 1, wherein one of the first resin layer or the second resin layer is a thiol-ene resin composition, and an other of the first resin layer or the second resin layer is a non-thiolated resin composition.

9. A patterned substrate, comprising:
a multi-layer structure including:
a first resin layer positioned over a base support, the first resin layer comprising a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane;
a second resin layer positioned over the first resin layer, the second resin layer comprising a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, wherein the second functional group is orthogonal to the first functional group; and
an inert layer positioned between the first resin layer and the second resin layer, wherein the inert layer is inert to the first and second functional groups;
a plurality of discrete regions defined in the multi-layer structure and separated by exposed portions of the inert layer, each of the plurality of discrete regions including:
a depression defined through the inert layer and in the first resin layer; and
a pillar defined in the second resin layer and positioned adjacent to the depression.

10. The patterned substrate as defined in claim 9, further comprising:
a first primer set attached in each depression via the first functional group of the first resin layer; and
a second primer set attached to each pillar via the second functional group of the second resin layer.

11. The patterned substrate as defined in claim 9, further comprising:
a first polymeric hydrogel attached in each depression via the first functional group of the first resin layer;
a first primer set attached to the first polymeric hydrogel;
a second polymeric hydrogel attached to each pillar via the second functional group of the second resin layer; and
a second primer set attached to the second polymeric hydrogel.

12. A method, comprising:
contacting a multi-layer stack including a base support, a first resin layer over the base support, a second resin layer over the first resin layer, and a third resin layer over the second resin layer with a working stamp to define a plurality of discrete multi-depth features in the third resin layer, wherein:
each of the multi-depth features includes a deep portion and a shallow portion directly adjacent to the deep portion;
the first resin layer of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and
the second resin layer of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and
etching the multi-layer stack having the plurality of discrete multi-depth features defined therein i) at each of the deep portions to form a first portion of a multi-depth depression extending through the second resin layer and having a bottom defined by a surface of the first resin layer, and ii) at each of the shallow portions to form a second portion of the multi-depth depression and to expose a surface of the second resin layer.

13. The method as defined in claim 12, further comprising:
attaching a first primer set in the first portion of each multi-depth depression; and
attaching a second primer set in the second portion of each multi-depth depression.

14. The method as defined in claim 13, wherein prior to selectively attaching the first primer set and selectively attaching the second primer set, the method further comprises exposing the multi-layer stack to a silane in an organic solvent, thereby selectively silanizing a surface of one of: (i) the first resin layer or (ii) the second resin layer.

15. The method as defined in claim 14, wherein an other of the first resin layer or the second resin layer is resistant to silanization in the organic solvent.

16. The method as defined in claim 15, wherein prior to selectively attaching the first primer set and selectively attaching the second primer set, the method further comprises:
selectively attaching a first polymeric hydrogel to the silanized surface of the one of: (i) the first resin layer, or (ii) the second resin layer; and
selectively attaching a second polymeric hydrogel to the other of: (i) the first resin layer, or (ii) the second resin layer, which is resistant to silanization.

17. The method as defined in claim 14, wherein the silane is selected from the group consisting of norbornene silane and trimethoxysilane and the organic solvent is selected from the group consisting of acetonitrile and dimethyl sulfoxide.

18. The method as defined in claim 12, wherein one of the first resin layer or the second resin layer is an organic epoxy resin composition, and an other of the first resin layer or the second resin layer is a siloxane-based resin composition.

19. The method as defined in claim 12, wherein one of the first resin layer or the second resin layer is a thiol-ene resin composition, and an other of the first resin layer or the second resin layer is a non-thiolated resin composition.

20. A patterned substrate, comprising:
a multi-layer structure including:
a first resin layer positioned over a base support;
a second resin layer positioned over the first resin layer;
one of the first resin layer or the second resin layer comprising an epoxy siloxane and an other of the second resin layer or the first resin layer comprising a carbon-containing functional group; and
a third resin layer positioned over the second resin layer; and
a plurality of multi-depth depressions defined in the multi-layer structure and separated by exposed portions of the third resin layer, each of the plurality of multi-depth depressions including:
a depression defined through the second resin layer and having a bottom defined by a surface of the first resin layer; and
an exposed surface of the second resin layer positioned adjacent to the depression.

21. The patterned substrate as defined in claim 20, further comprising:
a first primer set attached to the bottom defined by the surface of the first resin layer; and
a second primer set attached to the exposed surface of the second resin layer.

22. The patterned substrate as defined in claim 20, further comprising:
a first polymeric hydrogel attached to the bottom defined by the surface of the first resin layer;
a first primer set attached to the first polymeric hydrogel;
a second polymeric hydrogel attached to the exposed surface of the second resin layer; and
a second primer set attached to the second polymeric hydrogel.

23. A method for patterning a surface of a substrate, comprising:
imprinting a third resin layer of a multi-layer stack to form a multi-height convex region including a first region with a first height and a second region with a second height that is smaller than the first height, wherein the multi-layer stack includes the third resin layer over a second resin layer over a first resin layer over a base support, wherein:
the first resin layer of the multi-layer stack comprises a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and
the second resin layer of the multi-layer stack comprises a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group is orthogonal to the first functional group; and
selectively etching the multi-layer stack i) at the first and second regions to form a multi-height protrusion including an exposed portion of the second resin layer and an exposed portion of the first resin layer, and ii) around the multi-height convex region to expose the base support.

24. The method as defined in claim 23, further comprising:
attaching a first primer set over the exposed portion of the first resin layer; and
attaching a second primer set over the exposed portion of the second resin layer.

25. The method as defined in claim 24, wherein prior to selectively attaching the first primer set over the exposed portion of the first resin layer and attaching the second primer set over the exposed portion of the second resin layer, the method further comprises exposing the multi-layer stack to a silane in an organic solvent, thereby selectively silanizing a surface of one of: (i) the exposed portion of the first resin layer, or (ii) the exposed portion of the second resin layer.

26. The method as defined in claim 25, wherein an other of the first resin layer or the second resin layer is resistant to silanization in the organic solvent.

27. The method as defined in claim 26, wherein prior to selectively attaching the first primer set over the exposed portion of the first resin layer and the second primer set over the exposed portion of the second resin layer, the method further comprises:
selectively attaching a first polymeric hydrogel to the silanized surface of the one of: (i) the exposed portion of the first resin layer, or (ii) the exposed portion of the second resin layer; and
selectively attaching a second polymeric hydrogel to the other of: (i) the exposed portion of the first resin layer, or (ii) the exposed portion of the second resin layer, which is resistant to silanization.

28. The method as defined in claim 25, wherein the silane is selected from the group consisting of norbornene silane and trimethoxysilane and the organic solvent is selected from the group consisting of acetonitrile and dimethyl sulfoxide.

29. The method as defined in claim 23, wherein one of the first resin layer or the second resin layer is an organic epoxy resin composition, and the other of the first resin layer or the second resin layer is a siloxane-based resin composition.

30. A patterned substrate, comprising:
a base support; and
a plurality of multi-height protrusions defined over the base support and separated by exposed portions of the base support, each of the multi-height protrusions including:
a first resin layer having an exposed surface, the first resin layer comprising a first polymer having a first functional group selected from the group consisting of an amino, an alkynyl, a cycloalkynyl, a cycloalkenyl, a carboxyl, a vinyl, a thiol, an acrylate, an epoxy, and an epoxy siloxane; and
a second resin layer over a portion of the first resin layer adjacent to the exposed surface, the second resin layer comprising a second polymer having a second functional group selected from the group consisting of an amino, an alkynyl, a cylcoalkynyl, a cycloalkenyl, a carboxyl, a vinyl, a thiol, an acrylate, an epoxy, and an epoxy siloxane, and the second functional group being orthogonal to the first functional group.

31. The patterned substrate as defined in claim 30, further comprising:
a first primer set attached to the exposed surface of the first resin layer; and
a second primer set attached to the second resin layer.

32. The patterned substrate as defined in claim 30, further comprising:
a first polymeric hydrogel attached to the exposed surface of the first resin layer;
a first primer set attached to the first polymeric hydrogel;
a second polymeric hydrogel attached to the second resin layer; and
a second primer set attached to the second polymeric hydrogel.

33. A working stamp, comprising:
a substrate having a planar surface; and
a plurality of discrete features formed in the substrate and separated from one another by the planar surface, each of the discrete features including:
a concave portion defined in the substrate and extending in a first direction from the planar surface; and
a convex portion defined in the substrate and extending in a second direction from the planar surface;
wherein the second direction is opposed to the first direction, and the concave and convex portions are directly adjacent to each other.
